(19) United States
(12) Patent Application Publication
(10) Pub. No.: US 2026/0153163 A1
(43) Pub. Date: Jun. 4, 2026

(54) POWER TRANSMISSION DEVICE

(71) Applicant: DENSO CORPORATON, Kariya-city (JP)

(72) Inventors: Takafumi MATSUMOTO, Kariya-city (JP); HIROTO INOUE, Kariya-city (JP); TAKURO SAHARA, Kariya-city (JP); TOKUHISA TAKEUCHI, Kariya-city (JP); SHIGEJI OISHI, Kariya-city (JP); HIROYUKI KAWASHIMA, Kariya-city (JP); KAZUKI FUKUSHIMA, Kariya-city (JP); KOICHI KAWATO, Kariya-city (JP); RIKU OUCHI, Kariya-city (JP); MIKIO MATSUDA, Nisshin-City (JP); TAKASHI KUSADA, Nisshin-City (JP)

(21) Appl. No.: 19/459,847

(22) Filed: Jan. 26, 2026

Related U.S. Application Data
(63) Continuation of application No. PCT/JP2024/026746, filed on Jul. 26, 2024.

(30) Foreign Application Priority Data
Jul. 31, 2023 (JP) 2023-125011
Jul. 15, 2024 (JP) 2024-113013

(51) Int. Cl. F16K 31/04; H02K 51/00

(52) U.S. Cl. CPC F16K 31/046; H02K 51/00

(57) ABSTRACT

An input shaft is rotated by input of driving force. A first output shaft is rotated by driving force transmitted from the input shaft. A second output shaft is provided at a position different from the position of the first output shaft, and is rotated by driving force transmitted from the input shaft. An output shaft switching unit switches between a first output state and a second output state. In the first output state, rotation of the second output shaft by the driving force is restricted, and rotation of the first output shaft by the driving force is permitted. In the second output state, rotation of the first output shaft by the driving force is restricted, and rotation of the second output shaft by the driving force is permitted.

### CROSS REFERENCE TO RELATED APPLICATION

The present application is a continuation application of International Patent Application No. PCT/JP2024/026746 filed on Jul. 26, 2024, which designated the U.S. and claims the benefit of priority from Japanese Patent Applications No. 2023-125011 filed on Jul. 31, 2023 and No. 2024-113013 filed on Jul. 15, 2024. The entire disclosures of all of the above applications are incorporated herein by reference.

### TECHNICAL FIELD

The present disclosure relates to a power transmission device.

### BACKGROUND

Conventionally, multiple electric valves are provided in a fluid circuit to control flow of fluid in a circuit.

### SUMMARY

A power transmission device according to an aspect of the present disclosure comprises: an input shaft configured to rotate by input of driving force; a first output shaft configured to rotate by driving force transmitted from the input shaft; and a second output shaft provided at a position different from a position of the first output shaft and configured to rotate by the driving force transmitted from the input shaft. The power transmission device may further comprise: an output shaft switching device configured to switch between a first output state, in which rotation of the second output shaft by the driving force is restricted and rotation of the first output shaft by the driving force is permitted, and a second output state, in which rotation of the first output shaft by the driving force is restricted and rotation of the second output shaft by the driving force is permitted.

### BRIEF DESCRIPTION OF THE DRAWINGS

The above object and other objects, features, and advantages of the present disclosure will become more apparent from the following detailed description with reference to the accompanying drawings.

FIG. 1 is a configuration diagram of an integration valve to which a power transmission device according to the first embodiment is applied.

FIG. 2 is a configuration diagram of a refrigeration cycle including an integration valve.

FIG. 3 is a cross-sectional view taken along line III-III in FIG. 1.

FIG. 4 is a cross-sectional view taken along line IV-IV in FIG. 1.

FIG. 5 is an explanatory diagram illustrating a first output state of the integration valve according to the first embodiment.

FIG. 6 is an explanatory diagram illustrating a second output state of the integration valve according to the first embodiment.

FIG. 7 is a configuration diagram of an integration valve to which a power transmission device according to the second embodiment is applied.

FIG. 8 is an explanatory diagram related to a configuration of an output shaft switching unit according to the second embodiment.

FIG. 9 is a configuration diagram of an integration valve to which a power transmission device according to the third embodiment is applied.

FIG. 10 is a configuration diagram of an integration valve to which a power transmission device according to the fourth embodiment is applied.

FIG. 11 is a cross-sectional view taken along line XI-XI in FIG. 10.

FIG. 12 is an explanatory diagram illustrating a configuration of a drag generation portion according to the fourth embodiment.

FIG. 13 is a cross-sectional view illustrating a drag generation portion according to the fourth embodiment.

FIG. 14 is an explanatory diagram illustrating a first output state of an integration valve according to the fourth embodiment.

FIG. 15 is an explanatory diagram illustrating a second output state of the integration valve according to the fourth embodiment.

FIG. 16 is a cross-sectional view illustrating the first modification of the drag generation portion in the present disclosure.

FIG. 17 is a cross-sectional view illustrating the second modification of the drag generation portion in the present disclosure.

### DETAILED DESCRIPTION

Hereinafter, examples of the present disclosure will be described.

According to an example, multiple electric valves are provided in a fluid circuit in order to control flow of fluid in a circuit. An electric valve is configured to transmit driving force output from one driving source to one specific output shaft.

An electric valve is used as a dehumidification control valve or an electronic expansion valve in a refrigeration cycle, and transmits driving force generated by a stepping motor as a driving source to a needle valve via various members to adjust a valve opening degree. That is, the driving force generated by one driving source is output to one specific output destination (that is, the needle valve).

In an example, multiple electric valves are provided in one fluid circuit (that is, the refrigeration cycle system). In an example, one driving source and one output destination (valve body) may be provided for each of the plurality of electric valves. This configuration may hardly satisfy demand of downsizing a mounting space for a fluid circuit.

In view of this point, as a measure for implementing space saving regarding mounting of the fluid circuit, a configuration using an integration valve, for the fluid circuit, in which a driving source can be commonly used has been studied. In other words, it is desired to develop a power transmission device capable of switching a driving force to a plurality of output destinations, the driving force generated by one driving source, and outputting the driving force.

A power transmission device according to an example of the present disclosure comprises: an input shaft configured to rotate by input of driving force; a first output shaft configured to rotate by driving force transmitted from the input shaft; a second output shaft provided at a position different from a position of the first output shaft and configured to rotate by the driving force transmitted from the input shaft; and an output shaft switching unit configured to switch between a first output state, in which rotation of the second output shaft by the driving force is restricted and rotation of the first output shaft by the driving force is permitted, and a second output state, in which rotation of the first output shaft by the driving force is restricted and rotation of the second output shaft by the driving force is permitted.

Therefore, according to the power transmission device, by switching between the first output state and the second output state by the output shaft switching unit, the output destination of the driving force generated by one driving source can be appropriately switched to the first output shaft or the second output shaft. That is, since the outputs from the first output shaft and the second output shaft can be implemented by one driving source, the configuration using the power transmission device can be downsized.

Further, in the first output state of the output shaft switching unit, the rotation of the second output shaft by the driving force is restricted and the rotation of the first output shaft by the driving force is permitted, and in the second output state, the rotation of the first output shaft by the driving force is restricted and the rotation of the second output shaft by the driving force is permitted.

That is, in both of the first output state and the second output state, the driving force is transmitted to the first output shaft and the second output shaft regardless of whether the first output shaft and the second output shaft rotate. Therefore, according to the power transmission device, even when switching occurs by the output shaft switching unit, the output aspects of the first output shaft and the second output shaft can be controlled with high accuracy.

Hereinafter, a plurality of embodiments for carrying out the present disclosure will be described with reference to the drawings. In each embodiment, parts corresponding to matters described in the preceding embodiment are denoted by the same reference numerals, and redundant description may be omitted. In a case where only part of the configuration is described in each embodiment, other embodiments described above can be applied to other parts of the configuration. It is possible to not only combine portions specifically indicating that combinations are possible in the respective embodiments, but also partially combine the embodiments even if it is not explicitly described unless there is a problem in the combination.

### First Embodiment

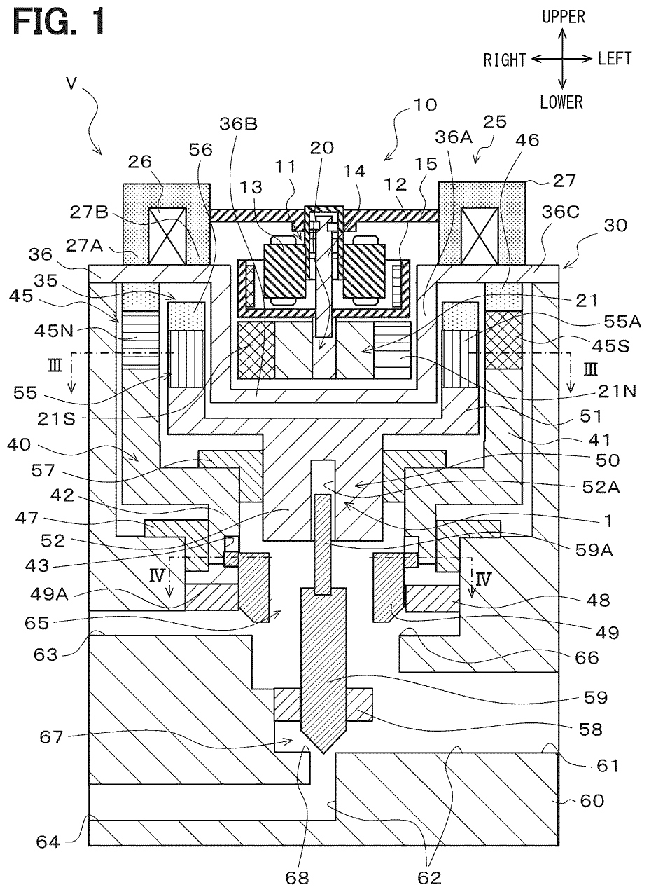

An embodiment to which the power transmission device according to the present disclosure is applied will be described with reference to FIGS. 1 to 6. In the first embodiment, the power transmission device according to the present disclosure is applied to an integration valve V in which a plurality of valve devices in a fluid circuit is integrated. As illustrated in FIG. 1, the integration valve V is configured so that the output destination of the driving force output from a drive motor 11 is switched between a first pressure-reducing unit VA and a second pressure-reducing unit VB and transmitted by a power transmission device 1.

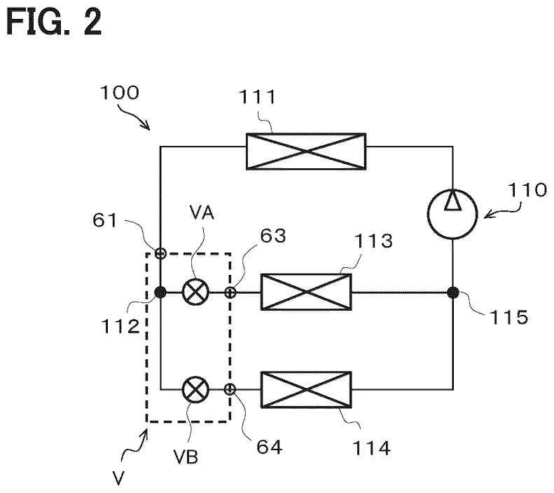

As illustrated in FIG. 2, the first pressure-reducing unit VA and the second pressure-reducing unit VB in the first embodiment constitute the integration valve V having a function of integrating two expansion valves connected in parallel with each other in a refrigeration cycle 100 that is a vapor compression refrigeration cycle.

Specifically, a configuration of the refrigeration cycle 100 according to the first embodiment will be described with reference to FIG. 2. The refrigeration cycle 100 includes a compressor 110, a condenser 111, the first pressure-reducing unit VA, the second pressure-reducing unit VB, a first evaporator 113, and a second evaporator 114.

In the first embodiment, the compressor 110 is an electric compressor that sucks, compresses, and discharges a refrigerant. The refrigeration cycle 100 is a subcritical cycle in which the high-pressure refrigerant pressure does not exceed the critical pressure of the refrigerant, and a fluorocarbon refrigerant (for example, R134a) is employed as the refrigerant circulating in the vapor compression refrigeration cycle.

The condenser 111 radiates heat of the refrigerant discharged from the compressor 110 to condense the refrigerant. A refrigerant branching portion 112 is provided at the refrigerant outlet of the condenser 111. The refrigerant branching portion 112 branches the flow of the refrigerant flowing out of the condenser 111 into a flow of the refrigerant toward the first pressure-reducing unit VA and a flow of the refrigerant toward the second pressure-reducing unit VB.

The first pressure-reducing unit VA constitutes part of the integration valve V according to the first embodiment, and decompresses part of the refrigerant condensed by the condenser 111. The first evaporator 113 is connected downstream of the first pressure-reducing unit VA in the refrigerant flow. The first evaporator 113 causes the refrigerant decompressed in the first pressure-reducing unit VA to absorb external heat to evaporate the refrigerant.

The second pressure-reducing unit VB constitutes part of the integration valve V as in the first pressure-reducing unit VA, and decompresses the other part of the refrigerant condensed by the condenser 111. The second evaporator 114 is connected downstream of the second pressure-reducing unit VB in the refrigerant flow. The second evaporator 114 causes the refrigerant decompressed in the second pressure-reducing unit VB to absorb external heat to evaporate the refrigerant.

The refrigerant merging portion 115 is connected downstream of the first evaporator 113 in the refrigerant flow and downstream of the second evaporator 114 in the refrigerant flow. The refrigerant merging portion 115 merges the flow of the refrigerant flowing out of the first evaporator 113 and the flow of the refrigerant flowing out of the second evaporator 114 to cause the merged refrigerants flow out to the suction port of the compressor 110.

As shown in FIG. 2, the integration valve V according to the first embodiment is configured by integrating portions from the inflow port of the refrigerant branching portion 112 to the outflow port of the first pressure-reducing unit VA and the second pressure-reducing unit VB in the refrigeration cycle 100. That is, the integration valve V has a function of the refrigerant branching portion 112, a function of the first pressure-reducing unit VA, and a function of the second pressure-reducing unit VB.

Next, a specific configuration of the integration valve V according to the first embodiment will be described with reference to the drawings. As illustrated in FIG. 1, the integration valve V includes a drive unit 10 that generates a driving force, and a main body 30 having a refrigerant flow path including the first pressure-reducing unit VA and the second pressure-reducing unit VB, and includes the power transmission device 1 according to the present disclosure. The power transmission device 1 transmits the rotational driving force generated by the drive unit 10 to either the first pressure-reducing unit VA or the second pressure-reducing unit VB by switching the rotational driving force using the magnetic force.

The integration valve V is vertically provided in the refrigeration cycle 100. The vertically provided is an arrangement in which the axial direction of the valve body of each of the first pressure-reducing unit VA and the second pressure-reducing unit VB is substantially parallel to the gravity direction, and the drive unit 10 is above the main body 30.

As illustrated in FIG. 1, the drive unit 10 constitutes an upper portion of the integration valve V, and is adjacent to the upper face of the main body 30. The drive unit 10 includes the drive motor 11 that generates a rotational driving force by supplying electric power, an input shaft 20 to which the driving force generated by the drive motor 11 is input, and an output shaft switching unit 25 for switching an output destination of the driving force input from the input shaft 20. The output shaft switching unit 25 may correspond to an output shaft switching device.

The drive motor 11 is a motor that can be driven by position feedback control, and includes a rotor 12, a stator 13, and a shaft 14. As the drive motor 11, for example, a three-phase brushless motor, a stepping motor, or the like can be used.

The shaft 14 is rotatably supported by a motor holding plate 15 constituting the upper face of the integration valve V. The rotor 12 is attached to the shaft 14 and rotates integrally with the rotor 12. The shaft 14 is an output shaft of the drive motor 11 and constitutes part of an input shaft of the power transmission device 1.

The stator 13 is fixed to a motor case or the motor holding plate 15 (not illustrated), and includes a stator coil. The rotor 12 is formed in a cylindrical shape, and the stator 13 is provided inside the rotor 12. In the rotor 12, a plurality of pairs of magnets including N poles and S poles is provided along the circumferential direction. For example, it is assumed that four N poles and four S poles are provided on the circumferential surface of the rotor 12, and the number of poles Pr of the rotor 12 can be set to 8. The stator 13 and the rotor 12 output a driving force for rotating the shaft 14 by electromagnetic force.

The motor holding plate 15 is provided in a central portion of the output shaft switching unit 25 provided in an annular shape in an upper portion of the integration valve V. As described above, the motor holding plate 15 rotatably supports the shaft 14 of the drive motor 11.

Note that a circuit unit (not illustrated) is accommodated in the drive unit 10. The circuit unit includes a circuit board on which a plurality of electronic components for controlling the drive motor 11 is mounted. Furthermore, the circuit unit can execute control related to the switching operation of the output shaft in the integration valve V (that is, control of the output shaft switching unit 25).

The input shaft 20 is joined to a lower end of the shaft 14 of the drive motor 11. The input shaft 20 is attached so that its axis is aligned with an extension line of the rotation axis of the shaft 14. Therefore, the input shaft 20 rotates integrally with the rotor 12 and the shaft 14 by the drive of the drive motor 11.

An input-side magnet 21 is formed at the lower end of the input shaft 20. As described above, the input shaft 20 rotates together with the rotor 12 and the like when the rotational driving force generated by the drive motor 11 is input. Since the input-side magnet 21 is formed integrally with the input shaft 20, the input-side magnet 21 rotates with the input of the rotational driving force generated by the drive motor 11.

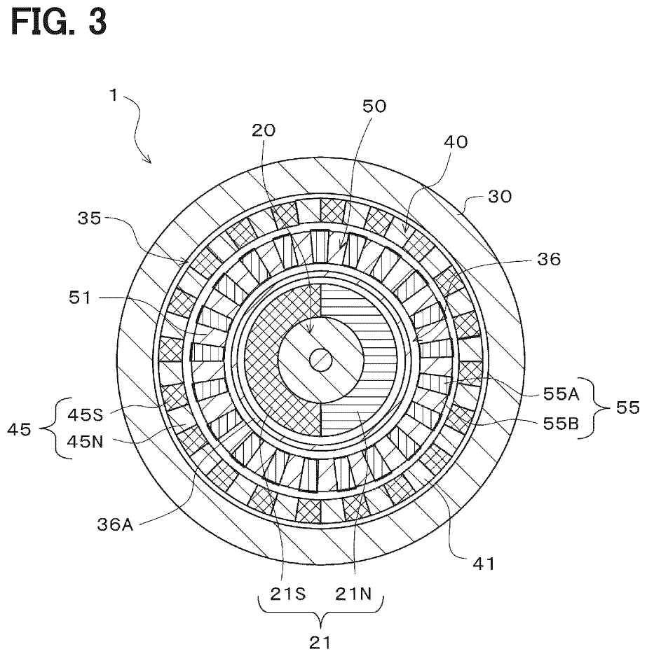

As illustrated in FIGS. 1 and 3, the input-side magnet 21 is formed in a disk shape at the lower end of the input shaft 20, and at least one set of a pair of magnets including an N pole 21N and an S pole 21S is provided along the circumferential direction on a side face (that is, a disk-shaped outer peripheral face) thereof. In this example, since the number of N poles 21N and the number of S poles 21S are each one, the number of poles Pin of the input-side magnet 21 is two.

In the upper portion of the integration valve V, the output shaft switching unit 25 is provided so as to surround the drive motor 11. As described above, the output shaft switching unit 25 is configured to switch the output destination of the rotational driving force generated by the drive motor 11 to either a first output shaft 40 or a second output shaft 50, and includes a switching coil 26 and a switching yoke 27.

The switching coil 26 is a DC coil annularly provided on a partition wall 36 constituting the upper face of the integration valve V. The switching coil 26 can switch between a case where a current flows in a predetermined direction and a case where a current flows in a direction opposite to the predetermined direction.

The switching yoke 27 is a magnetic yoke configured to connect the inner diameter and the outer diameter of the annular switching coil 26 via the upper portion of the switching coil 26. The switching yoke 27 can also be referred to as an iron annular member having a groove shape with the lower side open. In this case, the switching coil 26 is provided inside the groove shape.

When a direct current is applied to the switching coil 26 configured as described above to generate a magnetic field, magnetic forces of different poles are generated at the inner diameter end and the outer diameter end of the switching yoke 27. In the following description, the outer diameter end of the switching coil 26 is referred to as a first magnetic force generation portion 27A, and the inner diameter end of the switching coil 26 is referred to as a second magnetic force generation portion 27B.

When a current flows through the switching coil 26, a magnetic force is generated in each of a first magnetic force generation portion 27A and a second magnetic force generation portion 27B by the magnetic field generated in the switching coil 26. The polarity of the magnetic force generated in the first magnetic force generation portion 27A and the second magnetic force generation portion 27B is controlled by the direction of the current flowing through the switching coil 26.

For example, when a current flows through the switching coil 26 in a predetermined direction, the magnetic force generated in first magnetic force generation portion 27A indicates the S pole, and the magnetic force generated in second magnetic force generation portion 27B indicates the N pole. When a current flows through the switching coil 26 in a direction opposite to the predetermined direction, the magnetic force generated in first magnetic force generation portion 27A indicates the N pole, and the magnetic force generated in second magnetic force generation portion 27B indicates the S pole.

In addition, since the first magnetic force generation portion 27A and the second magnetic force generation portion 27B are attached so as to be in contact with the upper face of the partition wall 36, a magnetic force generated by energization to the switching coil 26 can be applied to the lower side of the partition wall 36.

As illustrated in FIG. 1, the partition wall 36 is provided below the drive unit 10 including the drive motor 11, the input shaft 20, and the output shaft switching unit 25. The partition wall 36 is a sealing member that partitions a drive unit 10 side space in the integration valve V and the power transmission device 1 from a main body 30 side space including the first output shaft 40 and the like, and seals the main body 30 side space.

Since the main body 30 side space includes the space through which the refrigerant circulating through the refrigeration cycle 100 flows in the integration valve V, the partition wall 36 prevents the refrigerant (high-pressure refrigerant) flowing through the main body 30 from leaking into the drive unit 10 side space.

The partition wall 36 is configured as, for example, a non-magnetic material or a member having a predetermined magnetic permeability. Specifically, the partition wall 36 is formed of stainless steel in which austenitic stainless steel such as SUS304, aluminum, or SUS305 is changed into martensite by work hardening to impart magnetism.

As described above, the partition wall 36 is coupled to the upper face of the main body 30 to seal the space formed inside the main body 30. That is, the partition wall 36 and the main body 30 form a pressure vessel having pressure resistance.

As illustrated in FIG. 1, the partition wall 36 is formed in a disk shape in which a central portion is recessed downward, and includes a sealing cylindrical portion 36A, a sealing bottom face portion 36B, and a sealing outer edge portion 36C. In the partition wall 36 according to the first embodiment, the sealing cylindrical portion 36A, the sealing bottom face portion 36B, and the sealing outer edge portion 36C are integrally molded in order to improve pressure resistance.

The sealing cylindrical portion 36A is a cylindrical portion constituting a side face portion of a portion recessed downward at the central portion of the partition wall 36. As illustrated in FIGS. 1 and 3, the sealing cylindrical portion 36A is located toward the outer diameter of the input-side magnet 21.

The sealing bottom face portion 36B is located below the input-side magnet 21 and closes the lower side of the sealing cylindrical portion 36A. As a result, the internal space of the sealing cylindrical portion 36A is partitioned from the main body 30 side space. The sealing outer edge portion 36C is a plate-like portion formed to expand radially outward at the upper end of the sealing cylindrical portion 36A. The sealing outer edge portion 36C is fixed to the upper face of the main body 30.

The sealing bottom face portion 36B may be formed in a disk shape in which the central portion is curved downward. In addition, the corner portion forming the boundary between the sealing cylindrical portion 36A and the sealing bottom face portion 36B may have a shape rounded at a predetermined curvature radius instead of a right angle. By adopting such a shape and processing, the pressure resistance of the partition wall 36 can be enhanced.

As illustrated in FIG. 1, the main body 30 constituting the lower portion of the integration valve V includes a mechanism accommodation portion 35 that accommodates various mechanisms for implementing the pressure reducing functions of the first pressure-reducing unit VA and the second pressure-reducing unit VB, and a flow path forming portion 60 in which a refrigerant flow path through which the refrigerant of the refrigeration cycle 100 flows is formed. The mechanism accommodation portion 35 is provided in an upper portion of the main body 30, and the flow path forming portion 60 constitutes a lower portion of the main body 30. The internal space (that is, the mechanism accommodation portion 35 and the partition wall 36) formed in the main body 30 corresponds to an example of an accommodation space.

As described above, various members for implementing the pressure reducing function of the first pressure-reducing unit VA and various members for implementing the pressure reducing function of the second pressure-reducing unit VB are accommodated in the mechanism accommodation portion 35 of the integration valve V.

Various members for implementing the pressure reducing function of the first pressure-reducing unit VA include the first output shaft 40, a first bearing member 47, a first screw member 48, and a first valve body 49. Various members for implementing the pressure reducing function of the second pressure-reducing unit VB include the second output shaft 50, a second bearing member 57, a second screw member 58, and a second valve body 59.

The first output shaft 40 of the integration valve V according to the first embodiment is an output shaft that rotates by the rotational driving force generated by the drive unit 10 and outputs the rotational driving force to the first valve body 49 constituting the first pressure-reducing unit VA.

As illustrated in FIG. 1, the first output shaft 40 is provided so as to have a rotation axis on an extension line of the rotation axis of the shaft 14 and the input shaft 20 described above, and includes a large diameter portion 41 and a small diameter portion 42. The rotation axis of the first output shaft 40 is provided so as to coincide with the center of the output shaft switching unit 25 formed in an annular shape.

The large diameter portion 41 is formed in a cylindrical shape and constitutes an upper portion of the first output shaft 40. Therefore, the large diameter portion 41 is accommodated in the mechanism accommodation portion 35 of the main body 30. The inner diameter dimension of the large diameter portion 41 is formed to be larger than at least an outer diameter dimension of the sealing cylindrical portion 36A of the partition wall 36. The diameter dimension of the large diameter portion 41 is formed to be the same as the diameter dimension of the first magnetic force generation portion 27A in the output shaft switching unit 25.

An output-side magnet 45 is provided in an upper portion of the large diameter portion 41. As illustrated in FIGS. 1 and 3, the output-side magnet 45 is formed in a cylindrical shape as in the large diameter portion 41, and is configured by arranging a plurality of pairs of magnets including N poles 45N and S poles 45S at substantially equal intervals along the circumferential direction. In this example, since the number of N poles 45N and the number of S poles 45S are 20, the number of poles Pf of the output-side magnet 45 is 40. The output-side magnet 45 has a different number of poles from the input-side magnet 21, and can be said to be a multipolar magnet having a larger number of poles than the input-side magnet 21.

As described above, the input-side magnet 21 of the input shaft 20 is provided toward the inner diameter of the sealing cylindrical portion 36A in the partition wall 36. The output-side magnet 45 is provided toward the outer diameter of the sealing cylindrical portion 36A. As illustrated in FIGS. 1 and 3, the output-side magnet 45 is provided so as to face the input-side magnet 21 via the sealing cylindrical portion 36A of the partition wall 36. Therefore, the rotational driving force input to the input shaft 20 can be transmitted to the first output shaft 40 by the magnetic force acting between the input-side magnet 21 and the output-side magnet 45.

A first switching magnet 46 is provided on the upper end face of the large diameter portion 41. The first switching magnet 46 is provided so that the upper side thereof has either the S pole or the N pole (for example, the S pole), and has an annular shape having the same diameter dimension as the large diameter portion 41. Therefore, as illustrated in FIG. 1, the first switching magnet 46 provided at the upper end of the large diameter portion 41 faces the first magnetic force generation portion 27A of the output shaft switching unit 25 via the sealing outer edge portion 36C of the partition wall 36. As a result, since the magnetic force generated in the first magnetic force generation portion 27A of the output shaft switching unit 25 can act on the first switching magnet 46, the operation of the first output shaft 40 can be controlled.

The small diameter portion 42 of the first output shaft 40 is formed in a cylindrical shape having a diameter smaller than that of the large diameter portion 41, and extends downward from a lower portion of the large diameter portion 41. The second output shaft 50 and the like described later are provided inside the small diameter portion 42.

The first valve body 49 is provided at a lower end portion of the small diameter portion 42. The first valve body 49 corresponds to a valve body of the first pressure-reducing unit VA, and is formed in a cylindrical shape having an outer diameter dimension smaller than the inner diameter of the small diameter portion 42.

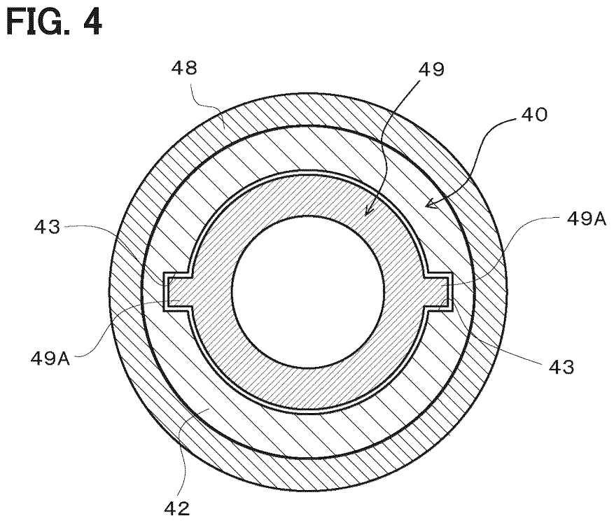

As illustrated in FIGS. 1 and 4, the small diameter portion 42 has a groove portion 43 at the lower end portion thereof. The groove portion 43 is formed by recessing an inner surface of the cylindrical small diameter portion 42 in a groove shape, and extends upward from a lower end edge of the small diameter portion 42.

The first valve body 49 has a projecting portion 49A at the upper end thereof. The projecting portion 49A is formed by projecting the outer surface of the cylindrical first valve body 49 radially outward, and extends downward from the upper end edge of the first valve body 49. An outer diameter dimension of the projecting portion 49A is smaller than an inner dimension of the groove portion 43. Therefore, the projecting portion 49A of the first valve body 49 can be fitted into the groove portion 43 of the small diameter portion 42. At this time, a certain interval is provided between the inner surface of the groove portion 43 and the outer surface of the projecting portion 49A.

As a result, the first valve body 49 can be rotated in accordance with the rotational operation of the first output shaft 40 by the cooperation of the groove portion 43 and the projecting portion 49A, and the rotational driving force transmitted to the first output shaft 40 can be transmitted to the first valve body 49. In addition, the first output shaft 40 can be moved in the rotation axis direction (that is, the vertical direction) with respect to the first valve body 49 by the cooperation of the groove portion 43 and the projecting portion 49A.

As illustrated in FIG. 1, the first bearing member 47 is provided below the mechanism accommodation portion 35 formed in the main body 30. The first bearing member 47 is fixed below the mechanism accommodation portion 35 of the main body 30 and rotatably supports the first output shaft 40. In addition, the first bearing member 47 allows the first output shaft 40 to move in the vertical direction within a predetermined range.

The first screw member 48 is provided below the first bearing member 47. The first screw member 48 is fixed in a first valve chamber 65 constituting the flow path forming portion 60 of the main body 30 and has a screw hole. The first screw member 48 has a female screw shape inside the screw hole thereof, and the first valve body 49 has a male screw shape at the outer peripheral face thereof.

A male screw of the first valve body 49 is screwed into a screw hole formed in the first screw member 48 to constitute a screw mechanism. As a result, when the first valve body 49 rotates, the first valve body 49 can move in the rotation axis direction, so that the opening degree in the first pressure-reducing unit VA can be adjusted.

The second output shaft 50 of the integration valve V is an output shaft that rotates by the rotational driving force generated by the drive unit 10 and outputs the rotational driving force to the second valve body 59 constituting the second pressure-reducing unit VB.

As illustrated in FIG. 1, the second output shaft 50 is provided so as to have a rotation axis on an extension line of the rotation axis of the shaft 14 and the input shaft 20 described above, and includes a cylindrical portion 51 and a shaft portion 52. The rotation axis of the second output shaft 50 is provided so as to coincide with the center of the output shaft switching unit 25 formed in an annular shape, and also coincides with the rotation axis of the first output shaft 40.

The cylindrical portion 51 is formed in a cylindrical shape and constitutes an upper portion of the second output shaft 50. The cylindrical portion 51 is provided toward the inner diameter of the second output shaft 50, and is located toward the outer diameter of the sealing cylindrical portion 36A of the partition wall 36. Therefore, the cylindrical portion 51 is accommodated in the mechanism accommodation portion 35 of the main body 30. The diameter dimension of the cylindrical portion 51 is formed to be the same as the diameter dimension of the second magnetic force generation portion 27B in the output shaft switching unit 25.

A magnetic flux modulation portion 55 is provided on an upper portion of the cylindrical portion 51. The magnetic flux modulation portion 55 is a magnetic modulation portion that modulates magnetic flux between the input-side magnet 21 and the output-side magnet 45, and is formed integrally with the second output shaft 50.

As illustrated in FIGS. 1 and 3, the magnetic flux modulation portion 55 is formed in a cylindrical shape as in the cylindrical portion 51, and includes a plurality of magnetic portions 55A and a plurality of non-magnetic portions 55B. Each of the magnetic portion 55A and the non-magnetic portion 55B has a fan shape, and the magnetic portions 55A are provided side by side at substantially equal intervals along the circumferential direction. The non-magnetic portion 55B is provided between the magnetic portions 55A. For example, the magnetic portion 55A is formed of a soft magnetic material (for example, iron-based metal), and the non-magnetic portion 55B is formed of a non-magnetic material (for example, stainless steel or resin).

The number of poles Pp of the magnetic flux modulation portion 55 is equal to the sum of the number of poles Pin of the input-side magnet 21 and the number of poles Pf of the output-side magnet 45. In the first embodiment, since the number of poles Pin of the input-side magnet 21 is 2 and the number of poles Pf of the output-side magnet 45 is 40, the number of poles Pp of the magnetic flux modulation portion 55 is 42. That is, the magnetic flux modulation portion 55 includes 21 magnetic portions 55A and 21 nonmagnetic portions 55B.

As described above, the input-side magnet 21 of the input shaft 20 is provided toward the inner diameter of the sealing cylindrical portion 36A in the partition wall 36. The output-side magnet 45 of the first output shaft 40 is provided radially outside the magnetic flux modulation portion 55 of the second output shaft 50. As illustrated in FIGS. 1 and 3, the magnetic flux modulation portion 55 is provided so as to face the input-side magnet 21 and the output-side magnet 45 via the sealing cylindrical portion 36A of the partition wall 36. Therefore, the magnetic flux modulation portion 55 can modulate the magnetic flux acting between the input-side magnet 21 and the output-side magnet 45.

When the rotation of the second output shaft 50 is stopped, the rotational driving force input to the input shaft 20 can be transmitted to the second output shaft 50 by the magnetic force acting between the input-side magnet 21, the output-side magnet 45, and the magnetic flux modulation portion 55.

A second switching magnet 56 is provided on an upper end face of cylindrical portion 51. The second switching magnet 56 is provided so that the upper side thereof has either the S pole or the N pole (for example, the S pole), and has an annular shape having the same diameter dimension as the cylindrical portion 51. The polarity indicated by the upper face of the second switching magnet 56 is provided to indicate the same polarity as the upper face of the first switching magnet 46.

As illustrated in FIG. 1, the second switching magnet 56 provided at the upper end of the cylindrical portion 51 faces the second magnetic force generation portion 27B of the output shaft switching unit 25 via the sealing outer edge portion 36C of the partition wall 36. As a result, since the magnetic force generated in the second magnetic force generation portion 27B of the output shaft switching unit 25 can act on the second switching magnet 56, the operation of the second output shaft 50 can be controlled.

The shaft portion 52 of the second output shaft 50 is a shaft-shaped portion extending downward from the lower portion of the cylindrical portion 51, and is formed integrally with the cylindrical portion 51. As described above, the shaft portion 52 is inserted into the small diameter portion 42 of the first output shaft 40 formed in a cylindrical shape. The second valve body 59 is provided at a lower end portion of the shaft portion 52. The second valve body 59 corresponds to a valve body in the second pressure-reducing unit VB, and constitutes a valve body of a so-called needle valve.

As illustrated in FIG. 1, the shaft portion 52 has an insertion hole 52A at a lower end portion thereof. The insertion hole 52A is drilled so as to extend in the axial direction upward from the lower end of the shaft portion 52 so as to include the rotation axis of the second output shaft 50.

The second valve body 59 has a protruding piece 59A at the upper end thereof. The protruding piece 59A protrudes so as to extend upward from the upper end of the second valve body 59 along the rotation axis of the second valve body 59. An outer diameter dimension of the protruding piece 59A is formed to be smaller than an inner diameter of the insertion hole 52A formed in the shaft portion 52. Therefore, the protruding piece 59A of the second valve body 59 can be inserted into the insertion hole 52A of the shaft portion 52, and the protruding piece 59A of the second valve body 59 can be meshed with the insertion hole 52A of the shaft portion 52. At this time, a predetermined interval can be provided between the inner surface of the insertion hole 52A and the outer surface of the protruding piece 59A.

As a result, the second valve body 59 can be rotated in accordance with the rotational operation of the second output shaft 50 by the cooperation of the insertion hole 52A and the protruding piece 59A, and the rotational driving force transmitted to the second output shaft 50 can be transmitted to the second valve body 59. In addition, the second output shaft 50 can be moved in the rotation axis direction (that is, the vertical direction) with respect to the second valve body 59 by the cooperation of the insertion hole 52A and the protruding piece 59A.

As illustrated in FIG. 1, the second bearing member 57 is provided below the mechanism accommodation portion 35 formed in the main body 30 and above the first bearing member 47. The second bearing member 57 is fixed to the main body 30 between the first output shaft 40 and the second output shaft 50, and rotatably supports the second output shaft 50. The second bearing member 57 allows the second output shaft 50 to move in the vertical direction within a predetermined range.

The second screw member 58 is provided below the second bearing member 57, the first bearing member 47, and the first screw member 48. The second screw member 58 is fixed in a second valve chamber 67 positioned below the first valve chamber 65 and has a screw hole. The second screw member 58 has a female screw shape inside the screw hole thereof, and the second valve body 59 has a male screw shape at the outer peripheral face thereof.

A male screw of the second valve body 59 is screwed into a screw hole formed in the second screw member 58 to constitute a screw mechanism. As a result, when the second valve body 59 rotates, the second valve body 59 can move in the rotation axis direction, so that the opening degree in the second pressure-reducing unit VB can be adjusted.

As shown in FIG. 1, the flow path forming portion 60 is provided in a lower portion of the main body 30 of the integration valve V. The flow path forming portion 60 is a portion where a refrigerant flow path 62 for allowing the refrigerant circulating in the refrigeration cycle 100 to flow into and out of the first pressure-reducing unit VA and the second pressure-reducing unit VB in the integration valve V is formed.

The main body 30 according to the first embodiment constitutes a body portion (that is, part of the housing) in the integration valve V, and is formed of a cast material (for example, AC4C) using an Al—Si—Mg-based aluminum alloy.

The flow path forming portion 60 of the main body 30 has an inflow port 61, a first outflow port 63, and a second outflow port 64, and has the refrigerant flow path 62 so as to connect these ports. The main body 30 has the inflow port 61 at the left side face thereof. As shown in FIG. 2, in the integration valve V according to the first embodiment, the inflow port 61 is connected to the outflow port of the condenser 111 of the refrigeration cycle 100.

The main body 30 has the first outflow port 63 and the second outflow port 64 at the right side face thereof. On the right side face of the main body 30, the first outflow port 63 is formed above the second outflow port 64. As illustrated in FIG. 2, the first outflow port 63 is connected to a refrigerant inlet of the first evaporator 113 in the refrigeration cycle 100, and the second outflow port 64 is connected to a refrigerant inlet of the second evaporator 114 in the refrigeration cycle 100.

As illustrated in FIG. 1, the main body 30 has the first valve chamber 65 and the second valve chamber 67 between the inflow port 61 and the first outflow port 63 and the second outflow port 64. The first valve chamber 65 is a valve chamber in which the first valve body 49 and the like constituting the first pressure-reducing unit VA are accommodated, and is formed below the mechanism accommodation portion 35. The first valve chamber 65 communicates with the mechanism accommodation portion 35 located above.

The first screw member 48 is fixed to the first valve chamber 65. Therefore, the first valve body 49 moves in the rotation axis direction inside the first valve chamber 65 by the screw mechanism configured in cooperation with the first screw member 48.

In a lower portion of the first valve chamber 65, a first valve seat 66 that can come into contact with the first valve body 49 that moves up and down is formed. The integration valve V can adjust the throttle opening degree in the first pressure-reducing unit VA by adjusting the relative positional relationship of the first valve body 49 with respect to the first valve seat 66. The refrigerant flow path 62 extending toward the first outflow port 63 is connected near the first valve seat 66 in the first valve chamber 65.

The second valve chamber 67 is a valve chamber in which the second valve body 59 and the like constituting the second pressure-reducing unit VB are accommodated, and is formed below the first valve chamber 65. The second valve chamber 67 communicates with the first valve chamber 65 located above.

The second screw member 58 is fixed to the second valve chamber 67. Therefore, the second valve body 59 moves in the rotation axis direction inside the second valve chamber 67 by the screw mechanism configured in cooperation with the second screw member 58.

In a lower part of the second valve chamber 67, a second valve seat 68 that can come into contact with the second valve body 59 that moves up and down is formed. The integration valve V can adjust the throttle opening degree in the second pressure-reducing unit VB by adjusting the relative positional relationship of the second valve body 59 with respect to the second valve seat 68. The refrigerant flow path 62 extending toward the second outflow port 64 is connected near the second valve seat 68 in the second valve chamber 67.

In the integration valve V, a portion where the first valve chamber 65 and the second valve chamber 67 communicate with each other constitutes the refrigerant branching portion 112 in the refrigeration cycle 100.

In the integration valve V configured as described above, the power transmission device 1 switches between the first output state in which the pressure reduction amount of the first pressure-reducing unit VA is adjustable via the first output shaft 40 and the second output state in which the pressure reduction amount of the second pressure-reducing unit VB is adjustable via the second output shaft 50 to adjust the pressure reduction amount.

Hereinafter, the operation of switching the integration valve V to the first output state and the second output state and the operation of adjusting the pressure reduction amount will be described with reference to the drawings.

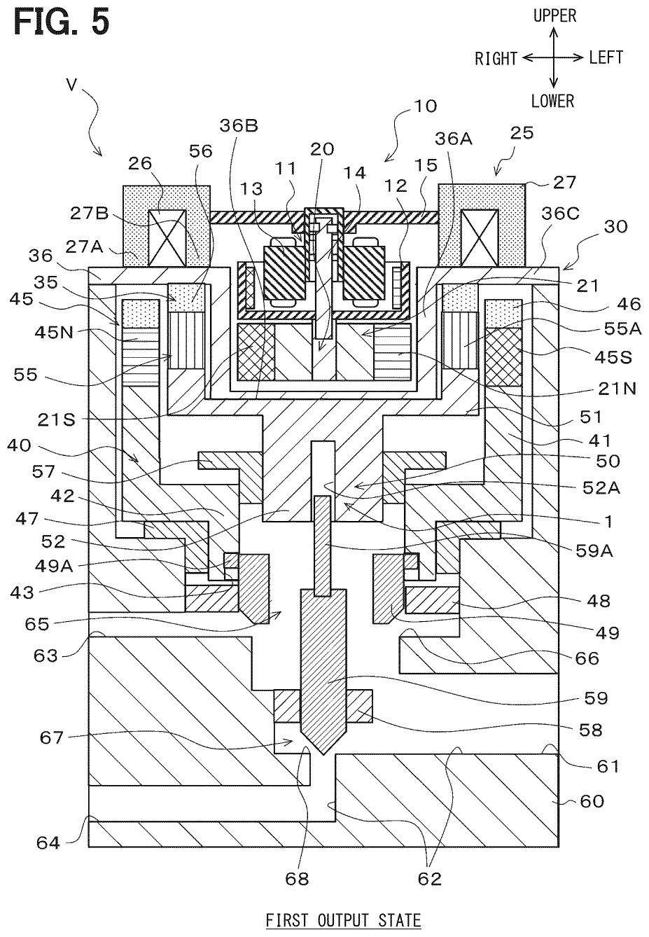

First, the first output state of the integration valve V and the power transmission device 1 will be described with reference to FIG. 5. The first output state is a state in which the output of the driving force by the first output shaft 40 is permitted and the output of the driving force by the second output shaft 50 is restricted by the operation control of the drive motor 11 and the output shaft switching unit 25.

Specifically, in the case of switching to the first output state, a direct current is supplied to the switching coil 26 of the output shaft switching unit 25 in a predetermined direction. When a direct current flows in a predetermined direction, a magnetic field is generated in the switching coil 26, and a magnetic force is generated at both ends of the switching yoke 27 in the output shaft switching unit 25. In the case of the first output state, the polarity of the magnetic force generated in the first magnetic force generation portion 27A indicates the S pole, and the polarity of the magnetic force generated in the second magnetic force generation portion 27B indicates the N pole.

The magnetic force generated in the first magnetic force generation portion 27A and the second magnetic force generation portion 27B acts on the component of the mechanism accommodation portion 35 via the sealing outer edge portion 36C of the partition wall 36. As illustrated in FIG. 1 and the like, the first magnetic force generation portion 27A faces the first switching magnet 46 via the sealing outer edge portion 36C, and the second magnetic force generation portion 27B faces the second switching magnet 56 via the sealing outer edge portion 36C.

As described above, the first switching magnet 46 is attached to the first output shaft 40 so that the upper side indicates the S pole. Therefore, in the first output state, when a magnetic force is generated in the first magnetic force generation portion 27A, the first output shaft 40 repels the magnetic force and moves downward along the axial direction of the first output shaft 40 and the like so as to be away from the output shaft switching unit 25.

On the other hand, the second switching magnet 56 is attached to the second output shaft 50 so that the upper side indicates the S pole. Therefore, in the first output state, when a magnetic force is generated in the second magnetic force generation portion 27B, the second output shaft 50 is attracted by the magnetic force, and the second output shaft 50 moves upward along the axial direction of the second output shaft 50 and the like. As a result, the upper end face of the second output shaft 50 is brought into close contact with the sealing outer edge portion 36C of the partition wall 36 by the magnetic force of the second magnetic force generation portion 27B.

When the drive motor 11 is driven in this state, the rotational driving force generated by the drive motor 11 is transmitted to the first output shaft 40 and the second output shaft 50 by magnetic interaction among the input-side magnet 21, the magnetic flux modulation portion 55, and the output shaft switching unit 25.

In the first output state, the second output shaft 50 is attracted toward the output shaft switching unit 25 by the magnetic force generated in the second magnetic force generation portion 27B and is in close contact with the partition wall 36. Therefore, as a drag of the rotational driving force transmitted from the drive motor 11 to the second output shaft 50, a magnetic force generated in the second magnetic force generation portion 27B and a frictional force generated between the partition wall 36 and the second output shaft 50 act.

Here, in the first output state, the relationship between the driving force transmitted to the second output shaft 50 and the drag caused by the output shaft switching unit 25 and the like is determined so that the drag caused by the output shaft switching unit 25 and the like is larger than the driving force transmitted to the second output shaft 50. Therefore, the second output shaft 50 in the first output state is in a state where the driving force generated by the drive motor 11 is transmitted, but its rotation is hindered by the drag caused by the output shaft switching unit 25 and the like.

On the other hand, in the first output state, the first output shaft 40 is moved away from the output shaft switching unit 25 and away from the partition wall 36 by the magnetic force generated in the first magnetic force generation portion 27A. Therefore, no magnetic force or frictional force acts as a drag of the rotational driving force transmitted from the drive motor 11 to the first output shaft 40.

Therefore, in the first output state, the rotation by the driving force transmitted to the first output shaft 40 is not hindered by the drag caused by the output shaft switching unit 25 and the like. Therefore, the first output shaft 40 in the first output state is in a state in which the driving force generated by the drive motor 11 is transmitted and can be output to the first valve body 49 as an output destination.

When the drive motor 11 is driven in the first output state illustrated in FIG. 5, the rotational driving force generated by the drive motor 11 is transmitted to the first output shaft 40 and the second output shaft 50 by magnetic interaction among the input-side magnet 21, the magnetic flux modulation portion 55, and the output shaft switching unit 25. At this time, the second output shaft 50 remains stopped due to the magnetic force of the output shaft switching unit 25 or the like, but the first output shaft 40 rotates while decelerating at a predetermined reduction ratio with respect to the rotation of the drive motor 11. In the first embodiment, the reduction ratio is 20 from the configurations of the input-side magnet 21, the magnetic flux modulation portion 55, and the output-side magnet 45.

As described above, according to the integration valve V of the first embodiment, the first output shaft 40 and the first valve body 49 can be moved by operating the drive motor 11 in the first output state. That is, by controlling the rotation direction of the drive motor 11 in the first output state, the first valve body 49 can be brought close to and away from the first valve seat 66, and the throttle opening degree of the first pressure-reducing unit VA can be adjusted.

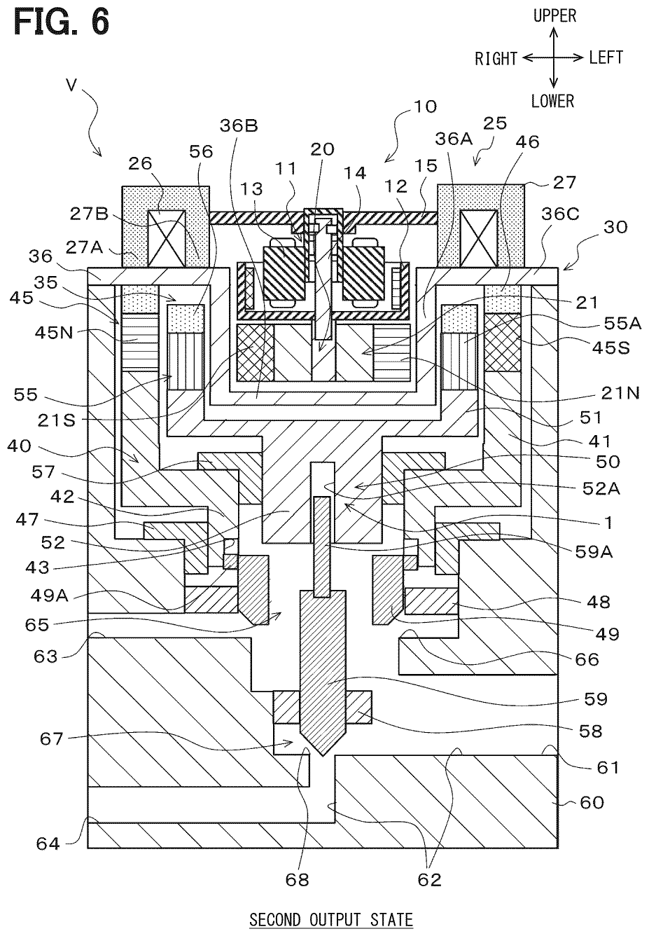

Next, the second output state of the integration valve V and the power transmission device 1 will be described with reference to FIG. 6. The second output state is a state in which the output of the driving force by the second output shaft 50 is permitted and the output of the driving force by the first output shaft 40 is restricted by the operation control of the drive motor 11 and the output shaft switching unit 25.

Specifically, in the case of switching to the second output state, a direct current is applied to the switching coil 26 of the output shaft switching unit 25 in a direction opposite to the predetermined direction in the case of the first output state. When a direct current flows, a magnetic field is generated in the switching coil 26, and a magnetic force is generated at both ends of the switching yoke 27 in the output shaft switching unit 25. In the case of the second output state, since the direct current flows in the direction opposite to the predetermined direction, the polarity of the magnetic force generated in the first magnetic force generation portion 27A indicates the N pole, and the polarity of the magnetic force generated in the second magnetic force generation portion 27B indicates the S pole.

As described in the first output state, the magnetic forces generated in the first magnetic force generation portion 27A and the second magnetic force generation portion 27B act on the first switching magnet 46 and the second switching magnet 56 via the sealing outer edge portion 36C of the partition wall 36.

As described above, since the first switching magnet 46 is attached to the first output shaft 40 so that the upper side indicates the S pole, in the second output state, when a magnetic force is generated in the first magnetic force generation portion 27A, the first output shaft 40 is attracted toward the output shaft switching unit 25 by the magnetic force. As a result, the upper end face of the first output shaft 40 moves in the axial direction of the first output shaft 40 by the magnetic force of the first magnetic force generation portion 27A and comes into close contact with the sealing outer edge portion 36C of the partition wall 36.

On the other hand, since the second switching magnet 56 is attached to the second output shaft 50 so that the upper side indicates the S pole, in the second output state, when the magnetic force is generated in the second magnetic force generation portion 27B, the second output shaft 50 repels the magnetic force and moves in a direction away from the output shaft switching unit 25 according to the axial direction.

When the drive motor 11 is driven in the second output state, the rotational driving force generated by the drive motor 11 is transmitted to the first output shaft 40 and the second output shaft 50 by magnetic interaction among the input-side magnet 21, the magnetic flux modulation portion 55, and the output shaft switching unit 25.

In the second output state, the first output shaft 40 is attracted toward the output shaft switching unit 25 by the magnetic force generated in the first magnetic force generation portion 27A and is in close contact with the partition wall 36. Therefore, as the drag of the rotational driving force transmitted from the drive motor 11 to the first output shaft 40, the magnetic force generated in the first magnetic force generation portion 27A and the frictional force generated between the partition wall 36 and the first output shaft 40 act.

In the second output state, the relationship between the driving force transmitted to the first output shaft 40 and the drag caused by the output shaft switching unit 25 and the like is determined so that the drag caused by the output shaft switching unit 25 and the like is larger than the driving force transmitted to the first output shaft 40. Therefore, the first output shaft 40 in the second output state is in a state where the driving force generated by the drive motor 11 is transmitted, but its rotation is hindered by the drag caused by the output shaft switching unit 25 and the like.

On the other hand, in the second output state, the second output shaft 50 is moved away from the output shaft switching unit 25 and away from the partition wall 36 by the magnetic force generated in the second magnetic force generation portion 27B. Therefore, no magnetic force or frictional force acts as a drag of the rotational driving force transmitted from the drive motor 11 to the second output shaft 50.

Therefore, in the second output state, the rotation by the driving force transmitted to the second output shaft 50 is not hindered by the drag caused by the output shaft switching unit 25 and the like. Therefore, the second output shaft 50 in the second output state is in a state in which the driving force generated by the drive motor 11 is transmitted and can be output to the second valve body 59 as an output destination.

When the drive motor 11 is driven in the second output state illustrated in FIG. 6, the rotational driving force generated by the drive motor 11 is transmitted to the first output shaft 40 and the second output shaft 50 by magnetic interaction among the input-side magnet 21, the magnetic flux modulation portion 55, and the output shaft switching unit 25. At this time, the first output shaft 40 remains stopped due to the magnetic force of the output shaft switching unit 25 or the like, but the second output shaft 50 rotates while decelerating at a predetermined reduction ratio with respect to the rotation of the drive motor 11. In the first embodiment, the reduction ratio is 21 from the configurations of the input-side magnet 21, the magnetic flux modulation portion 55, and the output-side magnet 45.

As described above, according to the integration valve V of the first embodiment, the second output shaft 50 and the second valve body 59 can be moved by operating the drive motor 11 in the second output state. That is, by controlling the rotation direction of the drive motor 11 in the second output state, the second valve body 59 can be brought close to and away from the second valve seat 68, and the throttle opening degree of the second pressure-reducing unit VB can be adjusted.

As illustrated in FIGS. 5 and 6, according to the integration valve V and the power transmission device 1 according to the first embodiment, the driving force generated by one drive motor 11 can be output by switching between the first output state in which the driving force is output to the first output shaft 40 and the second output state in which the driving force is output to the second output shaft 50. As a result, in the integration valve V and the power transmission device 1, the operation corresponding to the two valve devices of the first pressure-reducing unit VA and the second pressure-reducing unit VB can be implemented by one drive motor 11 as a driving source.

As a result, according to the integration valve V and the power transmission device 1 of the first embodiment, the valve device of the fluid circuit that requires a plurality of temperature states (for example, the refrigerant temperature at the first evaporator 113 and the second evaporator 114) such as the refrigeration cycle 100 illustrated in FIG. 2 can be implemented by one driving source. In addition, by implementing the integration valve V in which the driving sources of the plurality of valve devices is shared, the occupied space can be reduced, as compared with a case where each valve device is individually provided, and the occupied space of the fluid circuit can be downsized.

According to the integration valve V and the power transmission device 1 according to the first embodiment, in both the first output state and the second output state, the rotational driving force is transmitted via the magnetic gear including the input-side magnet 21, the magnetic flux modulation portion 55, and the output-side magnet 45. Through the magnetic gear, the rotational driving force generated by the drive motor 11 is decelerated and transmitted to the output shaft at a reduction ratio determined for each output state. As a result, the integration valve V and the power transmission device 1 can cause the first valve body 49 or the second valve body 59 to output the rotational driving force generated by the drive motor 11 in a state where the torque is increased while the rotational driving force is decelerated at the predetermined reduction ratio.

In the first output state illustrated in FIG. 5 and the second output state illustrated in FIG. 6, the rotational driving force generated by the drive motor 11 is transmitted to both the first output shaft 40 and the second output shaft 50. In other words, regardless of whether the rotation is permitted or restricted in the first output shaft 40 and the second output shaft 50, the rotational driving force generated by the drive motor 11 acts on any output shaft.

That is, since the driving force is continuously transmitted also to the output shaft whose rotation is restricted, it is possible to suppress the occurrence of the positional deviation at the timing when the rotation of the output shaft is permitted, and it is possible to enhance the accuracy of the opening degree control related to the first pressure-reducing unit VA and the second pressure-reducing unit VB.

In this state, the first output state and the second output state can be switched by changing the direction of the direct current flowing to the switching coil 26. Therefore, according to the integration valve V and the power transmission device 1, it is possible to quickly switch between the adjustment of the opening degree of the first pressure-reducing unit VA and the adjustment of the opening degree of the second pressure-reducing unit VB, and it is possible to enhance the responsiveness regarding the operation switching of the fluid circuit.

As illustrated in FIG. 1 and the like, the integration valve V and the input shaft 20 constituting the power transmission device 1 are provided in the drive unit 10, and the first output shaft 40 and the second output shaft 50 are provided in the mechanism accommodation portion 35 of the main body 30. The mechanism accommodation portion 35 of the main body 30 is partitioned from the drive unit 10 via the partition wall 36, and the mechanism accommodation portion 35 communicates with a space constituting the flow path forming portion 60 of the main body 30.

That is, in the integration valve V and the power transmission device 1, the first output shaft 40 and the second output shaft 50 are provided in a space through which the high-pressure refrigerant flowing through the refrigeration cycle 100 flows, and are partitioned from the drive unit 10 by the partition wall 36. Therefore, since the refrigerant sealing structure using the partition wall 36 can be implemented, the influence of the refrigerant on the operation of the drive unit 10 can be suppressed. Further, by adopting the configuration in which the partition wall 36 is attached to the main body 30, the pressure resistance against the high-pressure refrigerant can be enhanced.

As described above, the power transmission device 1 according to the first embodiment includes the input shaft 20, the first output shaft 40, and the second output shaft 50, and switches between the first output state and the second output state by the switching operation of the output shaft switching unit 25. In the first output state, the rotation of the second output shaft 50 by the driving force is restricted, and the rotation of the first output shaft 40 by the driving force is permitted. In the second output state, the rotation of the first output shaft 40 by the driving force is restricted and the rotation of the second output shaft 50 by the driving force is permitted.

Therefore, according to the integration valve V and the power transmission device 1, by switching between the first output state and the second output state by the output shaft switching unit 25, the output destination of the driving force generated by one driving source can be appropriately switched to the first output shaft or the second output shaft. That is, since the outputs from the first output shaft 40 and the second output shaft 50 can be implemented by one driving source, the configuration using the power transmission device 1 (the integration valve V and the refrigeration cycle 100) can be downsized.

In the first output state of the output shaft switching unit 25, the rotation of the second output shaft 50 by the driving force is restricted, and the rotation of the first output shaft 40 by the driving force is permitted. In the second output state, the rotation of the first output shaft 40 by the driving force is restricted, and the rotation of the second output shaft 50 by the driving force is permitted.

That is, in both the first output state and the second output state, the driving force is transmitted to the first output shaft 40 and the second output shaft 50 regardless of whether the first output shaft 40 and the second output shaft 50 rotate. Therefore, according to the power transmission device 1, even when the switching by the output shaft switching unit 25 occurs, it is possible to control the output aspects of the first output shaft 40 and the second output shaft 50 with high accuracy by suppressing the positional deviation of the output destination.

Further, as illustrated in FIG. 1 and the like, in the integration valve V and the power transmission device 1, the input shaft 20 includes the input-side magnet 21, and the first output shaft 40 includes the output-side magnet 45. The second output shaft 50 includes the magnetic flux modulation portion 55. The input shaft 20, the output-side magnet 45, and the magnetic flux modulation portion 55 constitute a so-called magnetic gear. With such a configuration, the integration valve V and the power transmission device 1 can output the driving force input to the input shaft 20 at a predetermined reduction ratio when the driving force is output from the first output shaft 40 and when the driving force is output from the second output shaft 50.

Further, according to the integration valve V and the power transmission device 1, the first output shaft 40 and the second output shaft 50 are provided in the mechanism accommodation portion 35 of the main body 30, and the mechanism accommodation portion 35 is partitioned by the partition wall 36 from the drive unit 10 in which the input shaft 20 is provided.

Thus, according to the power transmission device 1 and the integration valve V, the environment of the input shaft 20 can be made independent of the environment of the first output shaft 40 and the second output shaft 50. For example, even when the drive unit 10 is provided at the input shaft 20, the operation of the drive unit 10 and the input of the driving force to the input shaft 20 can be implemented without being affected by the environment of the first output shaft 40 and the second output shaft 50.

The output shaft switching unit 25 is provided outside the mechanism accommodation portion 35 corresponding to the accommodation space, and applies a magnetic force to the first output shaft 40 and the second output shaft 50 provided inside the mechanism accommodation portion 35 to restrict rotation of any one of the first output shaft 40 and the second output shaft 50. That is, the operations of the first output shaft 40 and the second output shaft 50 provided inside the accommodation space can be controlled in a non-contact manner through the magnetic force, and the first output state and the second output state can be switched without affecting the pressure environment inside the mechanism accommodation portion 35.

As illustrated in FIGS. 5 and 6, in the first embodiment, the output shaft switching unit 25 and the first switching magnet 46 of the first output shaft 40 and the second switching magnet 56 of the second output shaft 50 cause magnetic force to act in the axial direction of each output shaft to switch between the first output state and the second output state. The first output shaft 40 and the second output shaft 50 are provided radially inside and radially outside the same rotation axis. Therefore, when the output shaft switching unit 25 switches between the first output state and the second output state, a load caused by the magnetic force can be applied so as not to interfere with the operations of the first output shaft 40 and the second output shaft 50.

### Second Embodiment

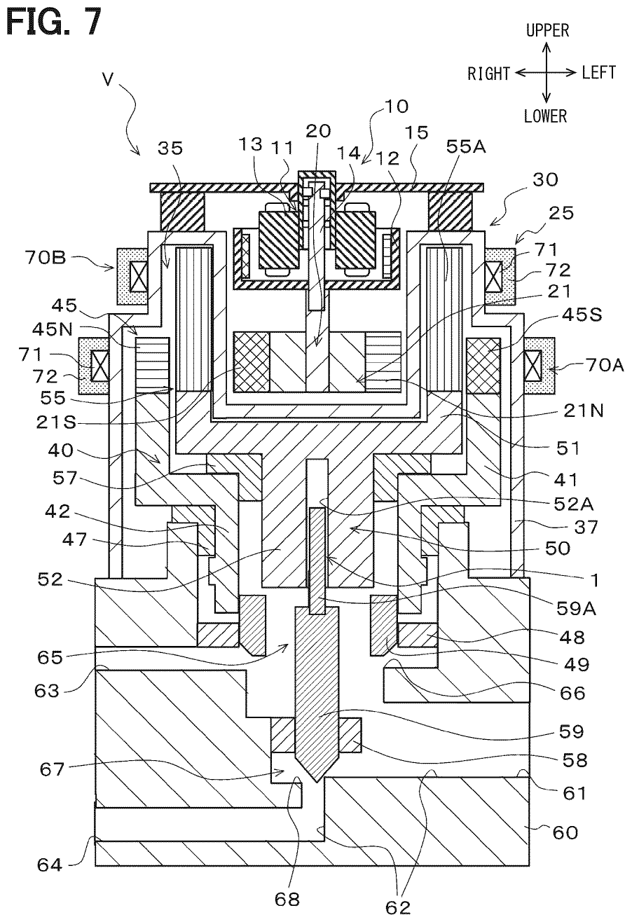

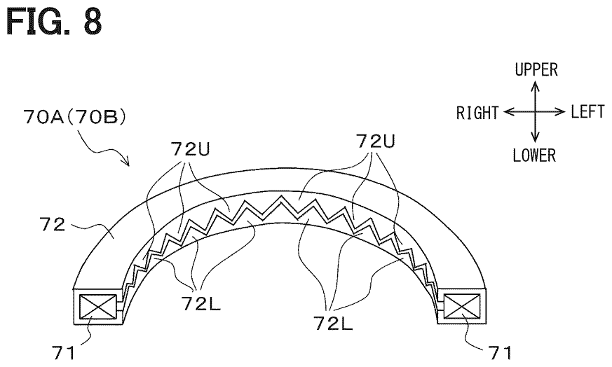

Next, the second embodiment different from the above-described embodiment will be described with reference to FIGS. 7 and 8. The second embodiment is different from the first embodiment in the configurations of the first output shaft 40, the second output shaft 50, and the output shaft switching unit 25. That is, the other configurations (for example, the drive unit 10, the main body 30, and the like) of the integration valve V and the power transmission device 1 are similar to those of the first embodiment. Therefore, in the following description, differences from the first embodiment in the integration valve V and the power transmission device 1 according to the second embodiment will be described in detail, and description of other parts will be omitted.

In the integration valve V and the power transmission device 1 according to the second embodiment, the first output shaft 40 is provided so as to have a rotation axis on an extension line of the rotation axis of the shaft 14 and the input shaft 20, and outputs a rotational driving force to the first valve body 49. The first output shaft 40 according to the second embodiment has the same configuration as that of the first embodiment described above except that the first switching magnet 46 is not provided. Therefore, as in the first embodiment, the first output shaft 40 according to the second embodiment includes the large diameter portion 41 in which the output-side magnet 45 is provided and the small diameter portion 42 in which the groove portion 43 is formed.

The second output shaft 50 according to the second embodiment is provided so as to have a rotation axis on an extension line of the rotation axis of the shaft 14 and the input shaft 20, and includes the cylindrical portion 51 in which the magnetic flux modulation portion 55 is provided, and the shaft portion 52 in which an insertion hole 52A is formed.

As illustrated in FIG. 7, in the second output shaft 50 according to the second embodiment, the second switching magnet 56 is not provided on the upper end face of the cylindrical portion 51. In the cylindrical portion 51 of the second output shaft 50 according to the second embodiment, the magnetic flux modulation portion 55 is formed longer than that of the first embodiment with respect to the dimension in the axial direction. That is, the magnetic flux modulation portion 55 according to the second embodiment is formed so that a region that does not overlap the output-side magnet 45 (an upper portion of the magnetic flux modulation portion 55 in FIG. 7) is generated.

The output-side magnet 45 of the first output shaft 40 is provided radially outside the lower portion of the magnetic flux modulation portion 55 according to the second embodiment. The lower portion of the magnetic flux modulation portion 55 is provided to face the input-side magnet 21 and the output-side magnet 45 via a pressure vessel 37. Therefore, according to the integration valve V and the power transmission device 1 according to the second embodiment, the driving force transmitted to the input shaft 20 can be transmitted to the first output shaft 40 and the second output shaft 50 by the cooperation of the lower portion of the magnetic flux modulation portion 55, the input-side magnet 21, and the output-side magnet 45.

As shown in FIG. 7, in the integration valve V and the power transmission device 1 according to the second embodiment, unlike the first embodiment, the pressure vessel 37 formed in a bottomed cylindrical shape is provided so as to cover the upper face of the flow path forming portion 60. The pressure vessel 37 constitutes an outer shell of the mechanism accommodation portion 35 in cooperation with the upper portion of the flow path forming portion 60.

As in the partition wall 36 of the first embodiment, the pressure vessel 37 is made of, for example, a non-magnetic material or a material having a predetermined magnetic permeability. Specifically, the pressure vessel 37 is formed of stainless steel in which austenitic stainless steel such as SUS304, aluminum, or SUS305 is changed into martensite by work hardening to impart magnetism.

As shown in FIG. 7, in the second embodiment, the wall face of the pressure vessel 37 is provided radially outside the output-side magnet 45 of the first output shaft 40. The wall face of the pressure vessel 37 is provided radially outside the upper portion of the magnetic flux modulation portion 55 of the second output shaft 50.

Here, in the integration valve V and the power transmission device 1 according to the second embodiment, a first fixing coil 70A and a second fixing coil 70B are provided as the output shaft switching unit 25. The first fixing coil 70A and the second fixing coil 70B are configured by so-called claw pole type fixing coils, and are annularly provided radially outside the pressure vessel 37.

The first fixing coil 70A is provided so as to face the output-side magnet 45 of the first output shaft 40 via the side wall portion of the pressure vessel 37, and generates a magnetic field that hinders the rotation of the first output shaft 40 in accordance with energization control.

The second fixing coil 70B is provided so as to face the upper portion of the magnetic flux modulation portion 55 of the second output shaft 50 via the side wall portion of the pressure vessel 37, and generates a magnetic field that hinders the rotation of the second output shaft 50 in accordance with the energization control.

Here, the configurations of the first fixing coil 70A and the second fixing coil 70B will be described in detail with reference to FIG. 8. In FIG. 8, part of the first fixing coil 70A is illustrated, but the second fixing coil 70B has the same configuration.

The first fixing coil 70A includes a coil body 71 and a tooth iron core 72. The coil body 71 of the first fixing coil 70A is a DC coil wound in an annular shape. The coil body 71 of the second fixing coil 70B has the same configuration except that the coil body is smaller in diameter than the coil body of the first fixing coil 70A.

The tooth iron core 72 of the first fixing coil 70A is formed by sheet metal working, and is provided so as to wrap from the radially outside to the radially inside the annular coil body 71. As illustrated in FIG. 8, a plurality of sets of upper tooth portions 72U and lower tooth portions 72L formed by the end portions of the tooth iron core 72 is provided radially inside the first fixing coil 70A.

The plurality of upper tooth portions 72U is formed by processing one end of a plate material constituting the tooth iron core 72 into a comb shape, and is provided radially inside from radially outside the coil body 71 via the upper side thereof. On the other hand, the plurality of lower tooth portions 72L is formed by processing the other end of the plate material constituting the tooth iron core 72 into a comb shape, and is provided radially inside from radially outside the coil body 71 via the lower side thereof.

As illustrated in FIG. 8, a predetermined interval is formed between the upper tooth portion 72U and the lower tooth portion 72L of the first fixing coil 70A, and the upper tooth portion 72U and the lower tooth portion 72L are combined so as to mesh with each other with the interval. The configurations of the upper tooth portion 72U and the lower tooth portion 72L are similar to those of the second fixing coil 70B.

In the first fixing coil 70A configured as described above, for example, the upper tooth portion 72U indicates the N pole and the lower tooth portion 72L indicates the S pole by energizing the coil body 71. Therefore, N poles and S poles are alternately provided radially inside the first fixing coil 70A in the circumferential direction. The magnetic force thus generated acts on the output-side magnet 45 of the first output shaft 40 via the side wall portion of the pressure vessel 37. In other words, in the first fixing coil 70A, a magnetic field that hinders rotation of the first output shaft 40 is generated by energization to the coil body 71.

Similarly, in the second fixing coil 70B, for example, the upper tooth portion 72U indicates the N pole and the lower tooth portion 72L indicates the S pole by energizing the coil body 71. Therefore, N poles and S poles are alternately provided radially inside the second fixing coil 70B in the circumferential direction. The magnetic force thus generated acts on the magnetic flux modulation portion 55 of the second output shaft 50 via the side wall portion of the pressure vessel 37. In other words, in the second fixing coil 70B, a magnetic field that hinders rotation of the second output shaft 50 is generated by energization to the coil body 71.

The first fixing coil 70A and the second fixing coil 70B are different from each other in the total number of the upper tooth portion 72U and the lower tooth portion 72L. The total number of the upper tooth portion 72U and the lower tooth portion 72L of the first fixing coil 70A is determined so that the number of magnetic poles by the upper tooth portion 72U and the lower tooth portion 72L is equal to the number of poles of the output-side magnet 45 of the first output shaft 40.

Therefore, between the upper tooth portion 72U and the lower tooth portion 72L of the first fixing coil 70A and the output-side magnet 45 of the first output shaft 40, for example, an attractive force caused by the S pole and a repulsive force caused by the N pole act in the rotation direction. Since the number of poles of the first fixing coil 70A and the output-side magnet 45 satisfies the above relationship, the rotation of the first output shaft 40 can be hindered to stop the rotation of the first output shaft 40.

On the other hand, the total number of upper tooth portions 72U and lower tooth portions 72L of the second fixing coil 70B is determined to be equal to the total number of magnetic portions 55A of the magnetic flux modulation portion 55 of the second output shaft 50.

Therefore, an attractive force acts in the rotation direction between the upper tooth portion 72U and the lower tooth portion 72L of the second fixing coil 70B and the magnetic portion 55A of the magnetic flux modulation portion 55 of the second output shaft 50. As described above, since the total number of the upper tooth portions 72U and the lower tooth portions 72L of the second fixing coil 70B and the number of the magnetic portions 55A of the second output shaft 50 are the same, it is possible to hinder the rotation of the second output shaft 50 and stop the rotation of the second output shaft 50.

Next, the first output state of the integration valve V and the power transmission device 1 according to the second embodiment configured as described above will be described. As described above, the first output state is a state in which the rotation of the second output shaft 50 using the driving force transmitted from the drive motor 11 is restricted and the rotation of the first output shaft 40 by the driving force is permitted.

As in the above-described embodiment, in the integration valve V and the power transmission device 1, when the driving force is generated by the start of the operation of the drive motor 11, the driving force is transmitted from the input shaft 20 to the first output shaft 40 and the second output shaft 50 by the cooperation of the input-side magnet 21, the output-side magnet 45, and the magnetic flux modulation portion 55.

Here, in order to implement the first output state, it is necessary to hinder the rotation of the second output shaft 50. In the case of the second embodiment, the coil body 71 of the second fixing coil 70B constituting the output shaft switching unit 25 is energized.

As a result, a magnetic field that hinders the rotation of the second output shaft 50 is generated between the upper tooth portion 72U and the lower tooth portion 72L of the second fixing coil 70B and each magnetic portion 55A of the second output shaft 50. Therefore, the rotation of the second output shaft 50 can be stopped against the driving force from the drive motor 11 by the energization control of the second fixing coil 70B.

At this time, the first fixing coil 70A is not energized, and no magnetic field is generated between the first fixing coil 70A and the output-side magnet 45. Therefore, the first output shaft 40 can rotate according to the driving force from the drive motor 11 to move the first valve body 49.

That is, by energizing the coil body 71 of the second fixing coil 70B, the integration valve V and the power transmission device 1 according to the second embodiment can hinder the rotation of the second output shaft 50 and allow the rotation of the first output shaft 40 to implement the first output state.

In addition, according to the integration valve V and the power transmission device 1 according to the second embodiment, when the first output state is implemented, a magnetic field for hindering the rotation of the second output shaft 50 is generated, and no other member is brought into physical contact with the second output shaft 50. Therefore, according to the integration valve V and the power transmission device 1 according to the second embodiment, it is possible to improve responsiveness related to switching to the first output state.

Next, the second output state of the integration valve V and the power transmission device 1 according to the second embodiment will be described. As described above, the second output state is a state in which the rotation of the first output shaft 40 using the driving force transmitted from the drive motor 11 is restricted and the rotation of the second output shaft 50 by the driving force is permitted.

Here, in order to implement the second output state, it is necessary to hinder the rotation of the first output shaft 40. In the case of the second embodiment, the coil body 71 of the first fixing coil 70A constituting the output shaft switching unit 25 is energized.

As a result, a magnetic field that hinders the rotation of the first output shaft 40 is generated between the upper tooth portion 72U and the lower tooth portion 72L of the first fixing coil 70A and the output-side magnet 45 of the first output shaft 40. Therefore, the rotation of the first output shaft 40 can be stopped against the driving force from the drive motor 11 by the energization control of the first fixing coil 70A.

At this time, the second fixing coil 70B is not energized, and no magnetic field is generated between the second fixing coil 70B and the magnetic portion 55A of the magnetic flux modulation portion 55. Therefore, the second output shaft 50 can rotate according to the driving force from the drive motor 11 to move the second valve body 59.

That is, by energizing the coil body 71 of the first fixing coil 70A, the integration valve V and the power transmission device 1 according to the second embodiment can hinder the rotation of the first output shaft 40 and allow the rotation of the second output shaft 50 to implement the second output state.

In addition, according to the integration valve V and the power transmission device 1 according to the second embodiment, when the second output state is implemented, a magnetic field for hindering the rotation of the first output shaft 40 is generated, and no other member is brought into physical contact with the first output shaft 40. Therefore, according to the integration valve V and the power transmission device 1 according to the second embodiment, it is possible to improve responsiveness related to switching to the second output state.

As described above, according to the power transmission device 1 according to the second embodiment, even in the aspect of generating the magnetic field that hinders the rotation at the time of switching to the first output state and the second output state, it is possible to obtain the operational effects obtained from the configuration and operation common to the above-described embodiment.

Further, according to the second embodiment, at the time of switching to the first output state and the second output state, the magnetic field that hinders the rotation is generated without bringing another member into physical contact with the output shaft. Therefore, the integration valve V and the power transmission device 1 according to the second embodiment can exhibit high responsiveness with respect to switching between the first output state and the second output state.

### Third Embodiment

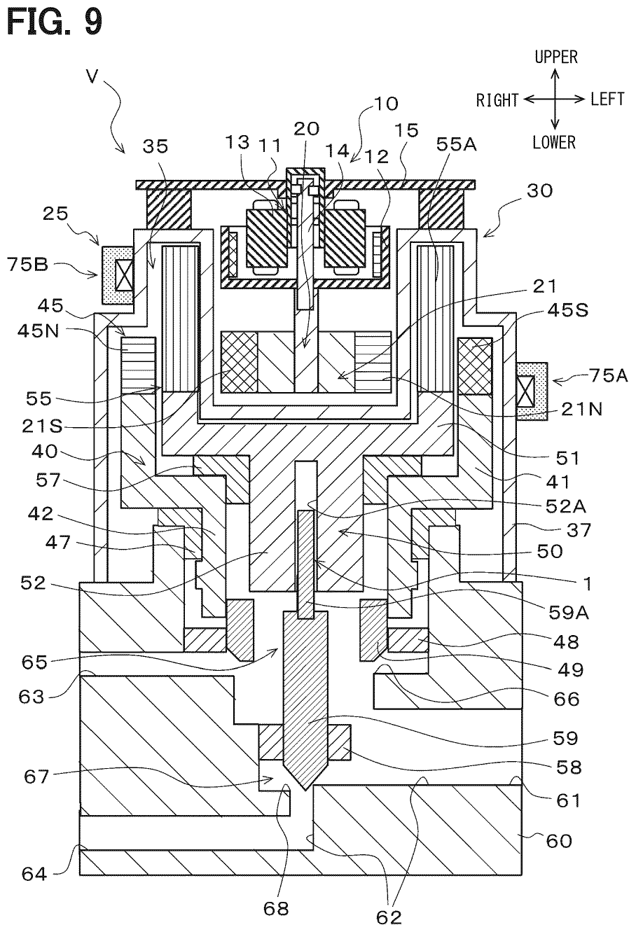

Next, the third embodiment different from the above-described embodiment will be described with reference to FIG. 9. The third embodiment is different from the above-described embodiment in the configuration of the output shaft switching unit 25. That is, other configurations (drive unit 10, main body 30, first output shaft 40, second output shaft 50, flow path forming portion 60, and the like) of the integration valve V and the power transmission device 1 according to the third embodiment are similar to those of the second embodiment described above. Therefore, in the following description, among the configurations of the integration valve V and the power transmission device 1 according to the third embodiment, differences from the above-described embodiment will be described in detail, and description of other parts will be omitted.

As illustrated in FIG. 9, in the integration valve V and the power transmission device 1 according to the third embodiment, the output shaft switching unit 25 includes a first electromagnet 75A and a second electromagnet 75B. The first electromagnet 75A includes a DC coil and a magnetic yoke, and is provided so as to face the output-side magnet 45 of the first output shaft 40 via a side face of the pressure vessel 37.

The first electromagnet 75A is provided in part of a range radially outside the output-side magnet 45 in the circumferential direction via the side face of the pressure vessel 37. Therefore, when the DC coil is energized to generate a magnetic force in the first electromagnet 75A, the magnetic force generated in the first electromagnet 75A acts on part of the output-side magnet 45 provided on the first output shaft 40 via the pressure vessel 37.

As a result, the first output shaft 40 is eccentric in a direction approaching or away from the first electromagnet 75A from a normal state in which no magnetic force is generated in the first electromagnet 75A by the action of the magnetic force generated between the first electromagnet 75A and part of the output-side magnet 45. As a result, due to the eccentricity of the first output shaft 40, the first output shaft 40 can come into contact with the first bearing member 47 to generate a frictional force, and the frictional force can hinder the rotation of the first output shaft 40.

As in the first electromagnet 75A, the second electromagnet 75B includes a DC coil and a magnetic yoke, and is provided to face an upper portion of the magnetic flux modulation portion 55 of the second output shaft 50 via a side face of the pressure vessel 37.

The second electromagnet 75B is provided in part of a range radially outside the upper portion of the magnetic flux modulation portion 55 in the circumferential direction via the side face of the pressure vessel 37. The range in which the second electromagnet 75B is provided in the circumferential direction can be determined regardless of the range in which the first electromagnet 75A is provided.

Therefore, when the DC coil is energized to generate a magnetic force in the second electromagnet 75B, the magnetic force generated in the second electromagnet 75B acts on part of the magnetic flux modulation portion 55 provided in the second output shaft 50 via the pressure vessel 37. More specifically, the magnetic force generated in the second electromagnet 75B acts on the upper portion of the magnetic portion 55A of the magnetic flux modulation portion 55.

As a result, the second output shaft 50 is eccentric in a direction approaching the second electromagnet 75B from a normal state in which no magnetic force is generated in the second electromagnet 75B by the action of the magnetic force generated between the second electromagnet 75B and part of the magnetic flux modulation portion 55. As a result, due to the eccentricity of the second output shaft 50, the second output shaft 50 can come into contact with the second bearing member 57 to generate a frictional force, and the frictional force can hinder the rotation of the second output shaft 50.

That is, in the third embodiment, any one of the first electromagnet 75A and the second electromagnet 75B constituting the output shaft switching unit 25 can cause a magnetic force to act on any one of the first output shaft 40 and the second output shaft 50 to cause eccentricity. The frictional force acts on the first output shaft 40 and the second output shaft 50 by coming into contact with other members due to eccentricity. Therefore, rotation of the eccentric output shaft out of the first output shaft 40 and the second output shaft 50 is hindered by the frictional force generated between the eccentric output shaft and the other members.

In other words, according to the integration valve V and the power transmission device 1 according to the third embodiment, the first output state and the second output state can be switched by selecting an electromagnet that generates a magnetic force in the radial direction among the first electromagnet 75A and the second electromagnet 75B constituting the output shaft switching unit 25.

Next, the first output state of the integration valve V and the power transmission device 1 according to the third embodiment configured as described above will be described. As described above, the first output state is a state in which the rotation of the second output shaft 50 using the driving force transmitted from the drive motor 11 is restricted and the rotation of the first output shaft 40 by the driving force is permitted.

In the integration valve V and the power transmission device 1 according to the third embodiment, when the driving force is generated by the start of the operation of the drive motor 11, the driving force is transmitted from the input shaft 20 to the first output shaft 40 and the second output shaft 50 by the cooperation of the input-side magnet 21, the output-side magnet 45, and the magnetic flux modulation portion 55.

Here, in order to implement the first output state, it is necessary to hinder the rotation of the second output shaft 50. In the case of the third embodiment, the DC coil of the second electromagnet 75B constituting the output shaft switching unit 25 is energized.

As a result, a magnetic force is generated between the second electromagnet 75B and the magnetic portion 55A of the magnetic flux modulation portion 55 of the second output shaft 50, and the second output shaft 50 is eccentric in a direction approaching the second electromagnet 75B. With the eccentricity of the second output shaft 50, the second output shaft 50 comes into contact with another member (for example, the second bearing member 57), so that the rotation of the second output shaft 50 is hindered. Therefore, the rotation of the second output shaft 50 can be stopped against the driving force from the drive motor 11 by the energization control of the second electromagnet 75B.

At this time, the DC coil of the first electromagnet 75A is not energized, and no magnetic force is generated between the first electromagnet 75A and the output-side magnet 45. Therefore, the first output shaft 40 can rotate according to the driving force from the drive motor 11 to move the first valve body 49.

That is, by energizing the DC coil of the second electromagnet 75B, the integration valve V and the power transmission device 1 according to the third embodiment can apply a magnetic force in the radial direction, hinder the rotation of the second output shaft 50, and allow the rotation of the first output shaft 40 to implement the first output state.

In addition, according to the integration valve V and the power transmission device 1 according to the third embodiment, in order to generate a magnetic force in the radial direction with respect to the second output shaft 50 to use the frictional force when implementing the first output state, the second electromagnet 75B is partially provided in the circumferential direction. Therefore, according to the integration valve V and the power transmission device 1 according to the third embodiment, it is possible to implement the switching to the first output state with a configuration downsized as compared with the configuration in which the output shaft switching unit 25 is provided over the entire region in the circumferential direction as in the above-described embodiment.

Next, the second output state of the integration valve V and the power transmission device 1 according to the third embodiment will be described. As described above, the second output state is a state in which the rotation of the first output shaft 40 using the driving force transmitted from the drive motor 11 is restricted and the rotation of the second output shaft 50 by the driving force is permitted.

Here, in order to implement the second output state, it is necessary to hinder the rotation of the first output shaft 40. In the case of the third embodiment, the DC coil of the first electromagnet 75A constituting the output shaft switching unit 25 is energized.

As a result, a magnetic force is generated between the first electromagnet 75A and part of the output-side magnet 45 of the first output shaft 40, and the first output shaft 40 is eccentric in a direction toward or away from the first electromagnet 75A. With the eccentricity of the first output shaft 40, the first output shaft 40 comes into contact with another member (for example, the first bearing member 47), so that the rotation of the first output shaft 40 is hindered. Therefore, the rotation of the first output shaft 40 can be stopped against the driving force from the drive motor 11 by the energization control of the first electromagnet 75A.

At this time, the DC coil of the second electromagnet 75B is not energized, and no magnetic force is generated between the second electromagnet 75B and part of the magnetic portion 55A of the magnetic flux modulation portion 55. Therefore, the second output shaft 50 can rotate according to the driving force from the drive motor 11 to move the second valve body 59.

That is, by energizing the DC coil of the first electromagnet 75A, the integration valve V and the power transmission device 1 according to the third embodiment can apply a magnetic force in the radial direction, hinder the rotation of the first output shaft 40, and allow the rotation of the second output shaft 50 to implement the second output state.

In addition, according to the integration valve V and the power transmission device 1 according to the third embodiment, in order to generate a magnetic force in the radial direction with respect to the first output shaft 40 and use a frictional force when implementing the second output state, the first electromagnet 75A is partially provided in the circumferential direction. Therefore, according to the integration valve V and the power transmission device 1 according to the third embodiment, it is possible to implement the switching to the second output state with a configuration downsized as compared with the configuration in which the output shaft switching unit 25 is provided over the entire region in the circumferential direction as in the above-described embodiment.

As described above, according to the power transmission device 1 according to the third embodiment, even in the aspect of applying the magnetic force in the radial direction at the time of switching between the first output state and the second output state, it is possible to obtain the operational effects obtained from the configuration and operation common to the above-described embodiment.

In the third embodiment, at the time of switching between the first output state and the second output state, a magnetic force is generated in the radial direction with respect to the first output shaft 40 or the second output shaft 50 to be eccentric, and a frictional force generated between the eccentric output shafts is used. Therefore, the first electromagnet 75A and the second electromagnet 75B constituting the output shaft switching unit 25 according to the third embodiment are partially provided in the circumferential direction.

As a result, according to the integration valve V and the power transmission device 1 according to the third embodiment, it is possible to implement switching to the first output state and the second output state with a configuration downsized as compared with the configuration in which the output shaft switching unit 25 is provided over the entire region in the circumferential direction as in the above-described embodiment.

### Fourth Embodiment

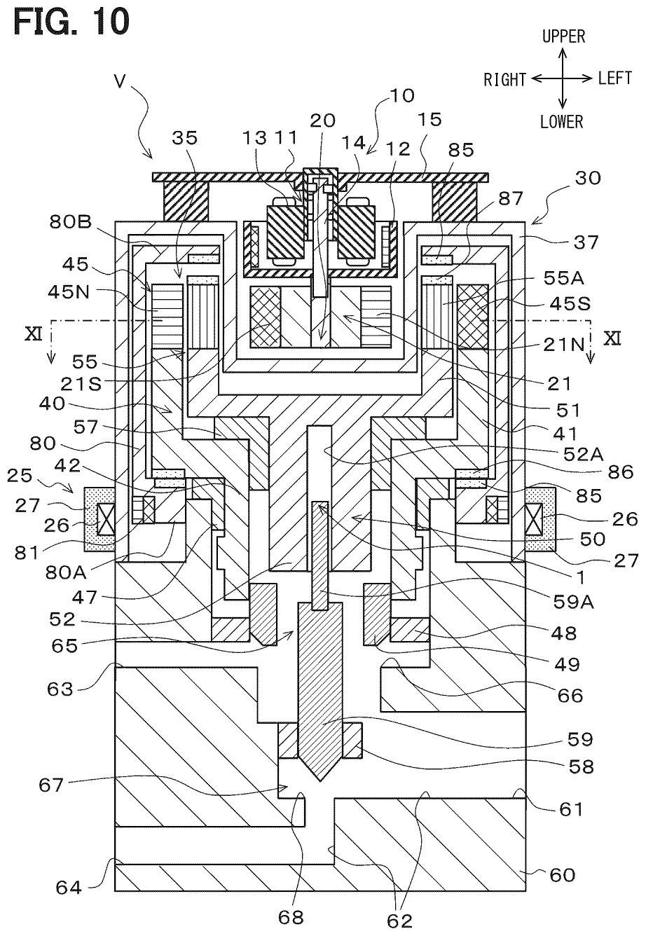

Next, the fourth embodiment different from the above-described embodiment will be described with reference to FIGS. 10 to 15. The fourth embodiment is different from the above-described embodiment in that a switching member 80 is included as a configuration of the output shaft switching unit 25 that switches between the first output state and the second output state. That is, other configurations (drive unit 10, main body 30, first output shaft 40, second output shaft 50, flow path forming portion 60, and the like) of the integration valve V and the power transmission device 1 are similar to those of the above-described embodiment. Therefore, in the following description, among the configurations of the integration valve V and the power transmission device 1 according to the fourth embodiment, differences from the above-described embodiment will be described in detail, and description of other parts will be omitted.

The integration valve V and the output shaft switching unit 25 of the power transmission device 1 according to the fourth embodiment include the switching coil 26 and the switching yoke 27 provided along the outer face of the pressure vessel 37, and the switching member 80 provided inside the mechanism accommodation portion 35.

As illustrated in FIG. 10, in the fourth embodiment, the switching member 80 constituting the output shaft switching unit 25 is provided inside the mechanism accommodation portion 35 and is provided to be movable along the axial direction of the first output shaft 40 and the like. The switching member 80 is formed in a cylindrical shape having a first rotation restriction portion 80A and a second rotation restriction portion 80B.

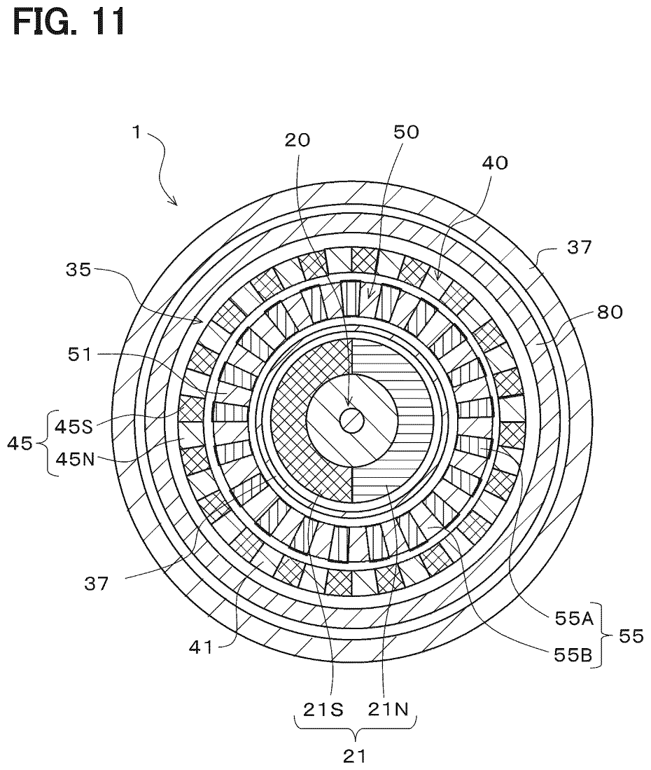

As illustrated in FIG. 11, the inner diameter of the switching member 80 having a cylindrical shape is set to be smaller than the maximum outer diameter of the pressure vessel 37 and larger than the outer diameter dimension of the large diameter portion 41 of the first output shaft 40. Therefore, in the fourth embodiment, the switching member 80 can move along the axial direction of the output shaft through between the pressure vessel 37 and the first output shaft 40 inside the mechanism accommodation portion 35.

The first rotation restriction portion 80A is provided below the switching member 80. The first rotation restriction portion 80A is an annular portion formed to extend radially inward from the lower end portion of the switching member 80 having a cylindrical shape. The first rotation restriction portion 80A is positioned below the large diameter portion 41 of the first output shaft 40.

In the fourth embodiment, the upper face of the first rotation restriction portion 80A approaches and is away from the lower face of the large diameter portion 41 of the first output shaft 40 along with the vertical movement of the switching member 80. That is, in the fourth embodiment, the upper face of the first rotation restriction portion 80A can be brought into contact with the lower face of the large diameter portion 41 of the first output shaft 40 by performing the energization control on the switching coil 26.

A member-side magnet 81 is provided on the side face located at the outer diameter of the first rotation restriction portion 80A. The member-side magnet 81 is provided so that any one of the S pole and the N pole (for example, N pole) faces radially outward.

As illustrated in FIG. 10, the switching coil 26 and the switching yoke 27 according to the fourth embodiment are provided so as to face the member-side magnet 81 of the switching member 80 via the side wall of the pressure vessel 37. By controlling the direction of the current with respect to the switching coil 26, the magnetic pole (S pole, N pole) generated in the switching yoke 27 can be switched.

By switching the type of magnetic pole of the switching yoke 27 and applying a magnetic force with the member-side magnet 81 of the switching member 80, the switching member 80 can be moved up and down inside the mechanism accommodation portion 35.

The second rotation restriction portion 80B is provided above the switching member 80. The second rotation restriction portion 80B is an annular portion formed to extend radially inward from the upper end of the switching member 80 having a cylindrical shape. The second rotation restriction portion 80B is positioned above the upper face of the large diameter portion 41 of the first output shaft 40 and the upper face of the cylindrical portion 51 of the second output shaft 50.

In the fourth embodiment, the lower face of the second rotation restriction portion 80B is away from and approaches the upper face of the cylindrical portion 51 of the second output shaft 50 along with the vertical movement of the switching member 80. That is, in the fourth embodiment, by performing the energization control on the switching coil 26, the lower face of the second rotation restriction portion 80B can be brought into contact with the upper face of the cylindrical portion 51 of the second output shaft 50.

As illustrated in FIG. 10, each of the first rotation restriction portion 80A and the second rotation restriction portion 80B of the switching member 80 has a drag generation portion 85. The drag generation portion 85 of the first rotation restriction portion 80A is formed in a portion of the first rotation restriction portion 80A, the portion facing the lower face of the large diameter portion 41 of the first output shaft 40.

The drag generation portion 85 of the second rotation restriction portion 80B is formed in a portion of the second rotation restriction portion 80B, the portion facing the upper face of the cylindrical portion 51 of the second output shaft 50. The drag generation portion 85 of each of the first rotation restriction portion 80A and the second rotation restriction portion 80B is formed in an annular shape around the center of the switching member 80 having a cylindrical shape and the position of the rotation axis of the first output shaft 40 and the second output shaft 50.

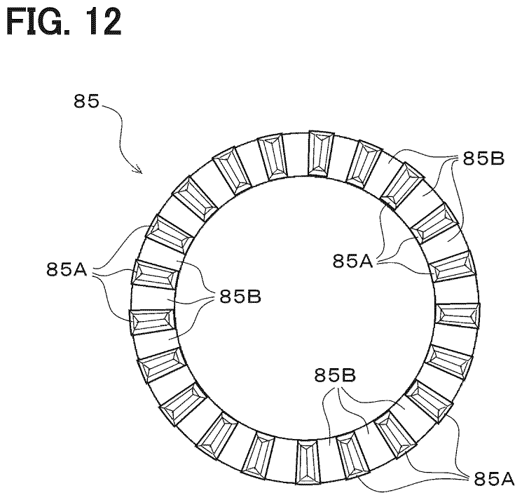

In each of the first rotation restriction portion 80A and the second rotation restriction portion 80B, the drag generation portion 85 is formed in an annular shape, and the plurality of protrusions 85A and the plurality of recesses 85B are alternately provided along the circumferential direction of the annular shape. As illustrated in FIG. 12, the protrusion 85A and the recess 85B in the drag generation portion 85 are formed so as to radially extend from the center position of the ring-shaped drag generation portion 85.

The drag generation portion 85 of the first rotation restriction portion 80A faces the lower face of the large diameter portion 41 of the first output shaft 40, and is provided so as to be able to contact the lower face of the large diameter portion 41 along with the vertical movement of the switching member 80. The lower face of the large diameter portion 41 of the first output shaft 40 corresponds to an example of a facing face. As illustrated in FIG. 10 and the like, a drag generation portion 86 having a plurality of protrusions 85A and a plurality of recesses 86B is formed at the lower face of the large diameter portion 41 of the first output shaft 40.

The drag generation portion 86 at the first output shaft 40 is formed in an annular shape as in the drag generation portion 85 of the first rotation restriction portion 80A. Also in the drag generation portion 86 at the first output shaft 40, a plurality of protrusions 86A and a plurality of recesses 86B extend radially from the center of the annular shape, and the protrusions 86A and the recesses 86B are alternately provided in the circumferential direction.

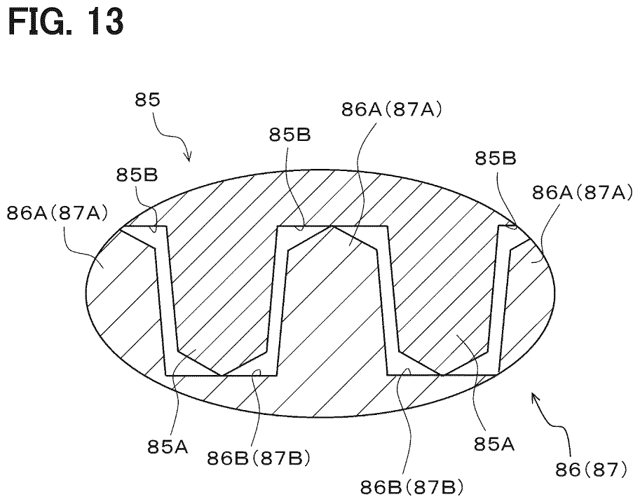

As a result, when the first rotation restriction portion 80A is brought into contact with the lower face of the large diameter portion 41 of the first output shaft 40, as illustrated in FIG. 13, the protrusion 85A and the recess 86B, and the recess 85B and the protrusion 86A can be brought into contact in a meshed state. The switching member 80 is provided so as to be movable in the axial direction of the output shaft but not to rotate about the axis of the output shaft. Therefore, by meshing the drag generation portion 85 of the first rotation restriction portion 80A with the drag generation portion 86 at the first output shaft 40, the drag with respect to the rotational driving force of the first output shaft 40 can be generated, and the rotation of the first output shaft 40 can be hindered and stopped.

The drag generation portion 85 of the second rotation restriction portion 80B faces the upper face of the cylindrical portion 51 of the second output shaft 50, and is provided so as to be able to contact the upper face of the cylindrical portion 51 along with the vertical movement of the switching member 80. The upper face of the cylindrical portion 51 of the second output shaft 50 corresponds to an example of a facing face. As illustrated in FIG. 10 and the like, a drag generation portion 87 having a plurality of protrusions 87A and a plurality of recesses 87B is formed at the upper face of the cylindrical portion 51 of the second output shaft 50.

The drag generation portion 87 at the second output shaft 50 is formed in an annular shape as in the drag generation portion 85 of the second rotation restriction portion 80B. Also in the drag generation portion 87 at the second output shaft 50, a plurality of protrusions 87A and a plurality of recesses 87B extend radially from the center of the annular shape, and the protrusions 87A and the recesses 87B are alternately provided in the circumferential direction.

Accordingly, when the second rotation restriction portion 80B is brought into contact with the upper face of the cylindrical portion 51 of the second output shaft 50, as illustrated in FIG. 13, the protrusion 85A and the recess 87B, and the recess 85B and the protrusion 87A can be brought into contact with each other in a meshed state. As described above, the switching member 80 is provided so as not to rotate about the axis of the output shaft. Therefore, by meshing the drag generation portion 85 of the second rotation restriction portion 80B with the drag generation portion 87 at the second output shaft 50, the drag with respect to the rotational driving force of the second output shaft 50 can be generated, and the rotation of the second output shaft 50 can be hindered and stopped.

Next, the first output state of the integration valve V and the power transmission device 1 according to the fourth embodiment configured as described above will be described. As described above, the first output state is a state in which the rotation of the second output shaft 50 using the driving force transmitted from the drive motor 11 is restricted and the rotation of the first output shaft 40 by the driving force is permitted.

In the integration valve V and the power transmission device 1 according to the fourth embodiment, when the driving force is generated by the start of the operation of the drive motor 11, the driving force is transmitted from the input shaft 20 to the first output shaft 40 and the second output shaft 50 by the cooperation of the input-side magnet 21, the output-side magnet 45, and the magnetic flux modulation portion 55.

Here, in order to implement the first output state, it is necessary to hinder the rotation of the second output shaft 50. In the case of the fourth embodiment, the switching member 80 is moved by the magnetic force generated by the energization to the switching coil 26, and the rotation of the second output shaft 50 is stopped.

Specifically, by passing a direct current in a predetermined direction to the switching coil 26, a magnetic force having a polarity different from the polarity of member-side magnet 81 located at the outer face of switching member 80 is generated at the lower end portion of switching yoke 27. As a result, a magnetic force acts between the lower end portion of the switching coil 26 and the member-side magnet 81 of the switching member 80 so as to attract each other.

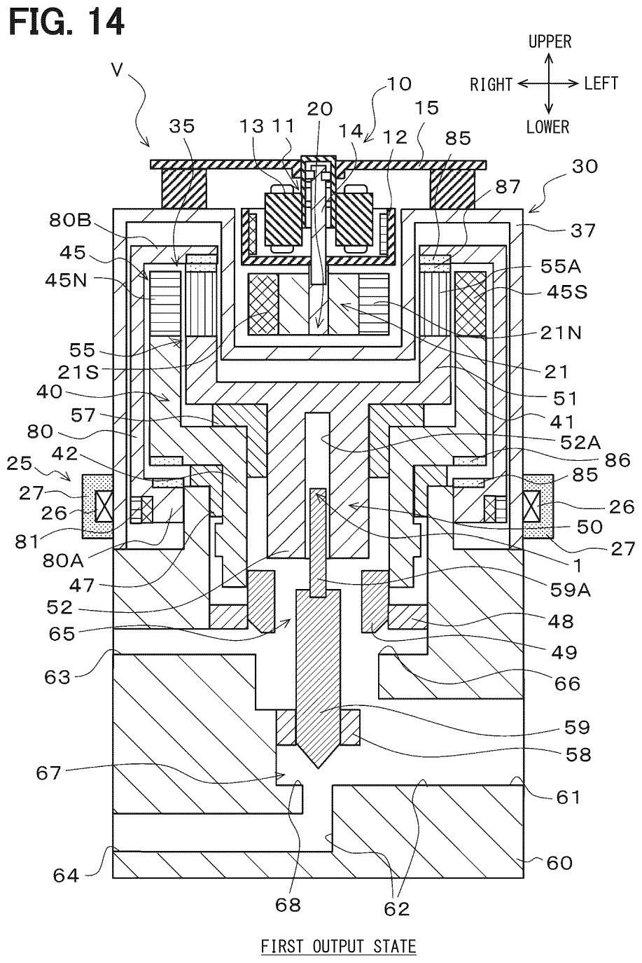

As a result, as illustrated in FIG. 14, the switching member 80 moves downward along the axial direction by the action of the magnetic force, and brings the second rotation restriction portion 80B into contact with the upper face of the cylindrical portion 51 of the second output shaft 50. At this time, since the drag generation portion 85 of the second rotation restriction portion 80B and the drag generation portion 87 at the second output shaft 50 mesh with each other, a drag that hinders the rotation of the second output shaft 50 can be generated, and the rotation of the second output shaft 50 can be stopped.

When the second rotation restriction portion 80B and the upper face of the cylindrical portion 51 of the second output shaft 50 come into contact with each other, the energization to the switching coil 26 can be stopped. When the energization of the switching coil 26 is stopped, the electromagnetic force from the switching yoke 27 is stopped, but the magnetic force in the member-side magnet 81 of the switching member 80 acts as an attractive force on the lower end portion of the switching yoke 27. Therefore, even in a state where the energization to the switching coil 26 is stopped, a state where the rotation of the second output shaft 50 is stopped can be maintained by the second rotation restriction portion 80B.

By moving the switching member 80 downward along the axial direction, the first rotation restriction portion 80A is away from the lower face of the large diameter portion 41 of the first output shaft 40. As a result, the first output shaft 40 is rotatable by the driving force transmitted from the input shaft 20 without being hindered by the switching member 80.

That is, by passing a direct current in a predetermined direction to the switching coil 26 the integration valve V and the power transmission device 1 according to the fourth embodiment can move the switching member 80, hinder the rotation of the second output shaft 50, and allow the rotation of the first output shaft 40 to implement the first output state.

According to the integration valve V and the power transmission device 1 of the fourth embodiment, when the first output state is implemented, the switching member 80 inside the mechanism accommodation portion 35 is moved by the magnetic force from the switching coil 26 and the switching yoke 27 outside the mechanism accommodation portion 35. Therefore, according to the fourth embodiment, switching to the first output state can be implemented without impairing the internal environment (that is, high pressure environment) of the mechanism accommodation portion 35.

According to the integration valve V and the power transmission device 1 according to the fourth embodiment, the switching member 80 moves along the axial direction of the first output shaft 40 and the like, applies a load in the axial direction to the second output shaft 50, and hinders the rotation of the second output shaft 50. The first output shaft 40 and the second output shaft 50 are provided inside and outside on the same central axis. Therefore, when a load is applied to the second output shaft 50 in the axial direction, the influence on the rotational operation of the first output shaft 40 can be suppressed.

Further, in the integration valve V and the power transmission device 1 according to the fourth embodiment, the drag generation portion 85 is provided in the second rotation restriction portion 80B of the switching member 80, and the drag generation portion 87 is provided on the upper face of the cylindrical portion 51 of the second output shaft 50. When the first output state is implemented, the drag generation portion 85 at the switching member 80 comes into contact with the drag generation portion 87 at the second output shaft 50 to generate a drag (frictional force) for hindering the rotation of the second output shaft 50.

The drag generation portion 85 and the drag generation portion 87 each have a plurality of recesses and a plurality of protrusions radially extending from the rotation center. Therefore, when the drag generation portion 85 and the drag generation portion 87 are brought into contact with each other, the protrusion 85A and the recess 87B, and the recess 85B and the protrusion 87A can be brought into contact with each other in a meshed state. As a result, the drag for hindering the rotation of the second output shaft 50 can be increased, and the integration valve V and the power transmission device 1 according to the fourth embodiment can reliably implement the first output state.

Next, the second output state of the integration valve V and the power transmission device 1 according to the fourth embodiment will be described. The second output state is a state in which the rotation of the first output shaft 40 using the driving force transmitted from the drive motor 11 is restricted and the rotation of the second output shaft 50 by the driving force is permitted.

Here, in order to implement the second output state, it is necessary to hinder the rotation of the first output shaft 40. In the case of the fourth embodiment, the switching member 80 is moved by the magnetic force generated by the energization to the switching coil 26, and the rotation of the first output shaft 40 is stopped.

Specifically, by passing a direct current in a predetermined direction to the switching coil 26, a magnetic force having a polarity different from the polarity of member-side magnet 81 located at the outer face of switching member 80 is generated at the upper end portion of switching yoke 27. That is, a direct current in a direction opposite to that in the first output state flows through the switching coil 26. As a result, a magnetic force acts between the upper end portion of the switching coil 26 and the member-side magnet 81 of the switching member 80 so as to attract each other.

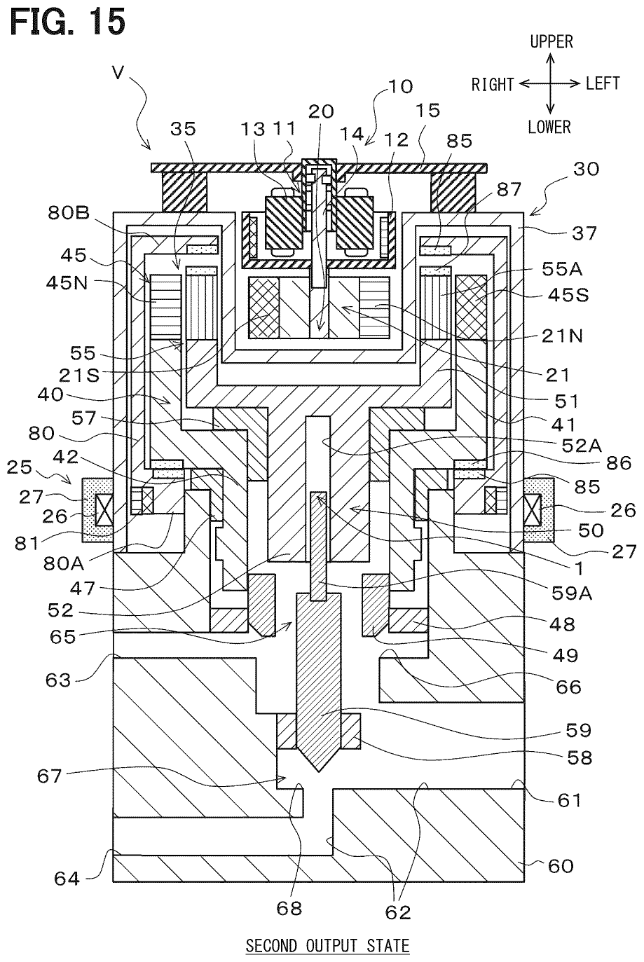

As a result, as illustrated in FIG. 15, the switching member 80 moves upward along the axial direction by the action of the magnetic force, and brings the first rotation restriction portion 80A into contact with the lower face of the large diameter portion 41 of the first output shaft 40. At this time, since the drag generation portion 85 of the first rotation restriction portion 80A and the drag generation portion 86 at the first output shaft 40 mesh with each other, a drag that hinders the rotation of the first output shaft 40 can be generated, and the rotation of the first output shaft 40 can be stopped.

The energization to the switching coil 26 can be stopped when the first rotation restriction portion 80A and the lower face of the large diameter portion 41 of the first output shaft 40 come into contact with each other. When the energization of the switching coil 26 is stopped, the electromagnetic force from the switching yoke 27 is stopped, but the magnetic force in the member-side magnet 81 of the switching member 80 acts as an attractive force on the upper end portion of the switching yoke 27. Therefore, even in a state where the energization to the switching coil 26 is stopped, a state where the rotation of the first output shaft 40 is stopped can be maintained by the first rotation restriction portion 80A.

By moving the switching member 80 upward along the axial direction, the second rotation restriction portion 80B is away from the upper face of the cylindrical portion 51 of the second output shaft 50. As a result, the second output shaft 50 is rotatable by the driving force transmitted from the input shaft 20 without being hindered by the switching member 80.

That is, by energizing the switching coil 26 with a direct current in a direction opposite to that in the first output state, the integration valve V and the power transmission device 1 according to the fourth embodiment can move the switching member 80, hinder the rotation of the second output shaft 50, and allow the rotation of the first output shaft 40. In other words, the integration valve V and the power transmission device 1 according to the fourth embodiment can implement the second output state by controlling the direct current to the switching coil 26.

According to the integration valve V and the power transmission device 1 of the fourth embodiment, when the second output state is implemented, the switching member 80 inside the mechanism accommodation portion 35 is moved by the magnetic force from the switching coil 26 and the switching yoke 27 outside the mechanism accommodation portion 35. Therefore, according to the fourth embodiment, switching to the second output state can be implemented without impairing the internal environment (that is, high pressure environment) of the mechanism accommodation portion 35.

According to the integration valve V and the power transmission device 1 according to the fourth embodiment, the switching member 80 moves along the axial direction of the first output shaft 40 and the like, applies a load in the axial direction to the first output shaft 40, and hinders the rotation of the first output shaft 40. The first output shaft 40 and the second output shaft 50 are provided inside and outside on the same central axis. Therefore, when a load is applied to the first output shaft 40 in the axial direction, the influence on the rotational operation of the second output shaft 50 can be suppressed.

Further, in the integration valve V and the power transmission device 1 according to the fourth embodiment, the drag generation portion 85 is provided in the first rotation restriction portion 80A of the switching member 80, and the drag generation portion 86 is provided at the lower face of the large diameter portion 41 of the first output shaft 40. When the second output state is implemented, the drag generation portion 85 at the switching member 80 comes into contact with the drag generation portion 86 at the first output shaft 40 to generate a drag (frictional force) for hindering the rotation of the first output shaft 40.

The drag generation portion 85 and the drag generation portion 86 each have a plurality of recesses and a plurality of protrusions radially extending from the rotation center. Therefore, when the drag generation portion 85 and the drag generation portion 86 are brought into contact with each other, the protrusion 85A and the recess 86B, and the recess 85B and the protrusion 86A can be brought into contact with each other in a meshed state. As a result, the drag for hindering the rotation of the first output shaft 40 can be increased, and the integration valve V and the power transmission device 1 according to the fourth embodiment can reliably implement the second output state.

As described above, according to the power transmission device 1 according to the fourth embodiment, even when the switching member 80 is moved by the electromagnetic force to switch between the first output state and the second output state, it is possible to obtain the operational effects obtained from the configuration and operation common to the above-described embodiment.

According to the integration valve V and the power transmission device 1 according to the fourth embodiment, when switching between the first output state and the second output state is implemented, the switching member 80 inside the mechanism accommodation portion 35 is moved by the magnetic force from the switching coil 26 and the switching yoke 27 outside the mechanism accommodation portion 35. Therefore, according to the fourth embodiment, since the switching member 80 is moved without physical contact from the outside of the mechanism accommodation portion 35, switching between the first output state and the second output state can be implemented without impairing the internal environment (that is, high pressure environment) of the mechanism accommodation portion 35.

According to the fourth embodiment, the switching member 80 moves along the axial direction of the first output shaft 40 or the like, applies a load in the axial direction to any one of the first output shaft 40 and the second output shaft 50, and hinders the rotation of the output shaft to which the load is applied. The first output shaft 40 and the second output shaft 50 are provided inside and outside on the same central axis. Therefore, when a load is applied to any one of the first output shaft 40 and the second output shaft 50 in the axial direction, it is possible to suppress the influence on the rotational operation of the other output shaft.

Furthermore, in the integration valve V and the power transmission device 1 according to the fourth embodiment, the drag generation portion 85 is provided at the switching member 80, and the drag generation portion 86 and the drag generation portion 87 are provided at the first output shaft 40 and the second output shaft 50, respectively. When switching between the first output state and the second output state is implemented, the drag generation portion 85 at the switching member 80 comes into contact with the drag generation portion 86 or the drag generation portion 87 at the output shaft to generate a drag (frictional force) for hindering the rotation of the output shaft.

The drag generation portion 85, the drag generation portion 86, and the drag generation portion 87 each have a plurality of recesses and a plurality of protrusions radially extending from the rotation center. Therefore, when the drag generation portion 85 at the switching member 80 is brought into contact with the drag generation portion 86 and the drag generation portion 87 on the output shaft, the protrusion 85A and the recess 86B (the recess 87B), and the recess 85B and the protrusion 86A (the protrusion 87A) can be brought into contact with each other in a meshed state. As a result, the drag for hindering the rotation of the first output shaft 40 and the second output shaft 50 can be increased, and the integration valve V and the power transmission device 1 according to the fourth embodiment can reliably switch between the first output state and the second output state.

The present disclosure is not limited to the above-described embodiments, and can be variously modified as follows without departing from the gist of the present disclosure.

In the above-described embodiments, the driving force is transmitted to the first output shaft 40 or the second output shaft 50 in a non-contact manner via the magnetic force of the input-side magnet 21, the output-side magnet 45, and the magnetic flux modulation portion 55 interacting with each other, but the present invention is not limited to this configuration. For example, it is possible to adopt a configuration in which the driving force from the input shaft 20 is decelerated at a predetermined reduction ratio and transmitted to the first output shaft 40 or the second output shaft 50 by a mechanical configuration such as a planetary gear mechanism.

In the above-described embodiments, as illustrated in FIGS. 5 and 6, the magnetic force generated in the output shaft switching unit 25 is directly applied to each of the first output shaft 40 and the second output shaft 50 to implement a state in which one rotation is restricted and the other rotation is permitted at the same time. However, the switching operation of the first output shaft 40 and the second output shaft 50 by the output shaft switching unit 25 is not limited to this aspect. For example, a configuration implementing a state in which a braking member that is displaced by the magnetic force generated in the output shaft switching unit 25 is used, the displacement of the braking member is used, and one rotation is restricted and the other rotation is permitted may be provided.

In the above-described embodiments, as illustrated in FIG. 1 and the like, the first magnetic force generation portion 27A and the second magnetic force generation portion 27B of the output shaft switching unit 25 are provided at the upper face portion of the sealing outer edge portion 36C of the partition wall 36, but the present invention is not limited to this aspect.

The arrangement of the first magnetic force generation portion 27A can adopt various aspects as long as it is possible to restrict the rotation of the first output shaft 40 by applying a magnetic force to the first switching magnet 46 of the first output shaft 40. As for the arrangement of the second magnetic force generation portion 27B, various aspects can be used as long as the rotation of the second output shaft 50 can be restricted by applying a magnetic force to the second switching magnet 56 of the second output shaft 50.

In the above-described fourth embodiment, the drag generation portion 86 and the drag generation portion 87 formed at the first output shaft 40 and the second output shaft 50, respectively, are in contact with the drag generation portion 85 formed at the switching member 80, but the present invention is not limited to this aspect. It is sufficient that the drag generation portion 85 is rotatably provided in contact with any one of the first output shaft 40 and the second output shaft 50 inside the mechanism accommodation portion 35.

For example, the drag generation portion 86 and the drag generation portion 87 at the first output shaft 40 and the second output shaft 50, and the corresponding drag generation portion 85 can be applied to the configuration of the first embodiment. Specifically, the drag generation portion 86 is formed at the upper face of the first output shaft 40 in the first embodiment, and the drag generation portion 87 is formed at the upper face of the second output shaft 50. The drag generation portions 85 facing a face constituting the inside of the sealing outer edge portion 36C of the partition wall 36 in the mechanism accommodation portion 35 is formed. With such a configuration, even in the configuration according to the first embodiment, a drag can be applied to any one of the first output shaft 40 and the second output shaft 50, and switching between the first output state and the second output state can be reliably implemented.

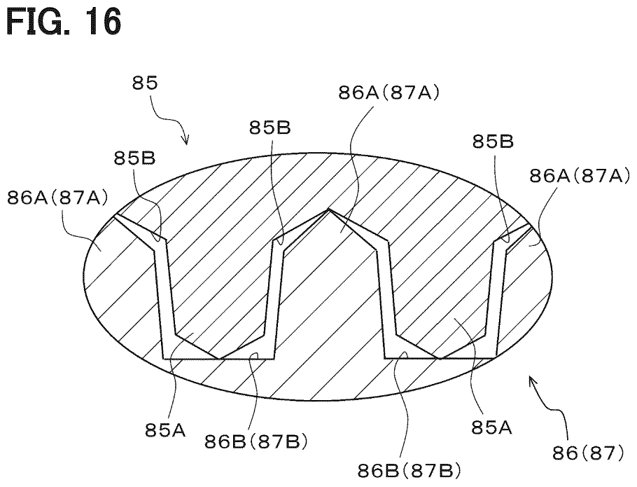

In the above-described fourth embodiment, the configuration illustrated in FIG. 13 is exemplified as the shapes of the drag generation portion 86 and the drag generation portion 87 formed at the first output shaft 40 and the second output shaft 50, and the drag generation portion 85 formed in the switching member 80, but the present invention is not limited to this aspect. For example, as illustrated in FIG. 16, the bottom face portions of the recess 86B and the recess 87B may be formed in a shape recessed toward the center in the width direction of each recess, and the distal end of the protrusion 85A of the drag generation portion 85 of the switching member 80 may be guided to the central portion in the width direction. As a result, the drag generation portion 85 at the switching member 80 can be deeply meshed with the drag generation portion 86 or the drag generation portion 87, and the drag that hinders the rotation of the first output shaft 40 and the second output shaft 50 can be reliably applied.

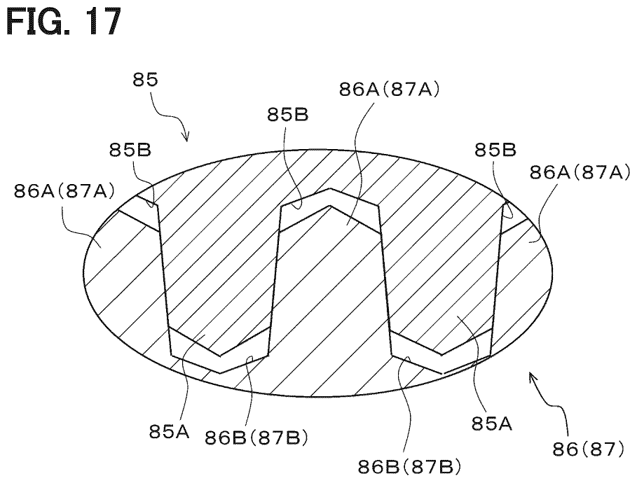

It is sufficient that the drag generation portion 86 and the drag generation portion 87 formed at the first output shaft 40 side and the second output shaft 50 side can mesh with the drag generation portion 85 formed at the switching member 80, and the contact portion between them can be appropriately changed. As described above, the distal end portion of the protrusion 86B of the drag generation portion 85 may be brought into contact with the bottom face portions of the recess 87B and the recess 85A. As illustrated in FIG. 17, the inner side faces of the recess 86B and the recess 87B and the side face of the protrusion 85A may be brought into contact with and meshed with each other, and the distal end of the protrusion 87 B of the drag generation portion 85 may be away from the bottom face portions of the recess 86B and the recess 85A.

Features of the power transmission device disclosed in the present specification are as follows.

### (Clause 1)

A power transmission device includes: an input shaft (20) configured to rotate by input of driving force; a first output shaft (40) configured to rotate by driving force transmitted from the input shaft; a second output shaft (50) provided at a position different from a position of the first output shaft and configured to rotate by the driving force transmitted from the input shaft; and an output shaft switching unit (25) configured to switch between a first output state, in which rotation of the second output shaft by the driving force is restricted and rotation of the first output shaft by the driving force is permitted, and a second output state, in which rotation of the first output shaft by the driving force is restricted and rotation of the second output shaft by the driving force is permitted.

### (Clause 2)

The power transmission device according to clause 1, in which the input shaft includes an input-side magnet (21) having a predetermined number of poles, the input-side magnet is configured to rotate integrally with the input shaft as the input shaft rotates by input of the driving force, the first output shaft includes an output-side magnet (45), which faces the input-side magnet and has a number of poles, which is different from a number of poles of the input-side magnet, the output-side magnet is configured to rotate integrally with the first output shaft as the first output shaft rotates, the second output shaft includes a magnetic flux modulation portion (55), which includes a plurality of magnetic portions (55A) arranged side by side, positioned between the input-side magnet and the output-side magnet, and configured to modulate a magnetic flux acting between the input-side magnet and the output-side magnet, and the magnetic flux modulation portion is configured to rotate integrally with the second output shaft as the second output shaft rotates.

### (Clause 3)

The power transmission device according to clause 1 or 2, in which the first output shaft and the second output shaft are provided inside an accommodation space (35), which is partitioned from a space in which the input shaft is provided.

### (Clause 4)

The power transmission device according to clause 3, in which the output shaft switching unit is provided outside the accommodation space, and the output shaft switching unit is configured to switch between the first output state and the second output state by applying magnetic force to an inside of the accommodation space to restrict rotation of one of the first output shaft and the second output shaft.

### (Clause 5)

The power transmission device according to clause 4, in which the output shaft switching unit is configured to switch between the first output state and the second output state by generating load in a radial direction of the first output shaft and the second output shaft by acting magnetic force on the inside of the accommodation space.

### (Clause 6)

The power transmission device according to clause 4, in which the output shaft switching unit is configured to switch between the first output state and the second output state by forming a magnetic field that hinders rotation of one of the first output shaft and the second output shaft.

### (Clause 7)

The power transmission device according to clause 4, in which the output shaft switching unit is configured to switch between the first output state and the second output state by generating load in an axial direction of the first output shaft and the second output shaft by acting magnetic force on the inside of the accommodation space.

### (Clause 8)

The power transmission device according to clause 7, further includes: a drag generation portion (85) provided inside the accommodation space and configured to generate drag by contact. The output shaft switching unit is configured to change a relative position between one of the first output shaft and the second output shaft, and the drag generation portion in the axial direction of the first output shaft and the second output shaft by acting magnetic force on the inside of the accommodation space, and switch between the first output state and the second output state by acting the drag between the one of the first output shaft and the second output shaft, and the drag generation portion.

### (Clause 9)

The power transmission device according to clause 8, in which the drag generation portion is provided inside the accommodation space and configured to be displaced in the axial direction of the first output shaft and the second output shaft, and the drag generation portion is configured to be displaced in the axial direction by action of the magnetic force from the output shaft switching unit to come into contact with the one of the first output shaft and the second output shaft.

### (Clause 10)

The power transmission device according to clause 8, in which the first output shaft and the second output shaft are provided inside the accommodation space and configured to be displaced in the axial direction of the first output shaft and the second output shaft, and the drag generation portion is provided at a position to be in contact with one of the first output shaft and the second output shaft when displaced in the axial direction by action of the magnetic force from the output shaft switching unit.

### (Clause 11)

The power transmission device according to any one of clauses 8 to 10, in which among surfaces of the first output shaft and the second output shaft, a facing face faces the drag generation portion in the axial direction of the first output shaft and the second output shaft, one of the drag generation portion and the facing face has a protrusion (85A, 86A, 87A) protruding in the axial direction of the first output shaft and the second output shaft, and an other of the drag generation portion and the facing face has a recess (85B, 86B, 87B) recessed in the axial direction of the first output shaft and the second output shaft and configured to be fitted with the protrusion.

The present disclosure is described based on the examples, and it is understood that present disclosure is not limited to the embodiments or the structures. The present disclosure includes various modification examples and modifications within the equivalent scope. Although various combinations and forms are set forth in the present disclosure, other combinations and configurations, including only one element, more, or less, are also intended to fall within the scope and spirit of the present disclosure.

What is claimed is:

1. A power transmission device comprising:
an input shaft configured to rotate by input of driving force;
a first output shaft configured to rotate by driving force transmitted from the input shaft;
a second output shaft provided at a position different from a position of the first output shaft and configured to rotate by the driving force transmitted from the input shaft; and
an output shaft switching device configured to switch between a first output state, in which rotation of the second output shaft by the driving force is restricted and rotation of the first output shaft by the driving force is permitted, and a second output state, in which rotation of the first output shaft by the driving force is restricted and rotation of the second output shaft by the driving force is permitted.

2. The power transmission device according to claim 1, wherein
the input shaft includes an input-side magnet having a predetermined number of poles,
the input-side magnet is configured to rotate integrally with the input shaft as the input shaft rotates by input of the driving force,
the first output shaft includes an output-side magnet, which faces the input-side magnet and has a number of poles, which is different from a number of poles of the input-side magnet,
the output-side magnet is configured to rotate integrally with the first output shaft as the first output shaft rotates,
the second output shaft includes a magnetic flux modulation portion, which includes a plurality of magnetic portions arranged side by side, positioned between the input-side magnet and the output-side magnet, and configured to modulate a magnetic flux acting between the input-side magnet and the output-side magnet, and
the magnetic flux modulation portion is configured to rotate integrally with the second output shaft as the second output shaft rotates.

3. The power transmission device according to claim 1, wherein
the first output shaft and the second output shaft are provided inside an accommodation space, which is partitioned from a space in which the input shaft is provided.

4. The power transmission device according to claim 3, wherein
the output shaft switching device is provided outside the accommodation space, and
the output shaft switching device is configured to switch between the first output state and the second output state by applying magnetic force to an inside of the accommodation space to restrict rotation of one of the first output shaft and the second output shaft.

5. The power transmission device according to claim 4, wherein
the output shaft switching device is configured to switch between the first output state and the second output state by generating load in a radial direction of the first output shaft and the second output shaft by acting magnetic force on the inside of the accommodation space.

6. The power transmission device according to claim 4, wherein
the output shaft switching device is configured to switch between the first output state and the second output state by forming a magnetic field that hinders rotation of one of the first output shaft and the second output shaft.

7. The power transmission device according to claim 4, wherein
the output shaft switching device is configured to switch between the first output state and the second output state by generating load in an axial direction of the first output shaft and the second output shaft by acting magnetic force on the inside of the accommodation space.

8. The power transmission device according to claim 7, further comprising:
a drag generation portion provided inside the accommodation space and configured to generate drag by contact, wherein
the output shaft switching device is configured to
change a relative position between one of the first output shaft and the second output shaft, and the drag generation portion in the axial direction of the first output shaft and the second output shaft by acting magnetic force on the inside of the accommodation space, and
switch between the first output state and the second output state by acting the drag between the one of the first output shaft and the second output shaft, and the drag generation portion.

9. The power transmission device according to claim 8, wherein
the drag generation portion is provided inside the accommodation space and configured to be displaced in the axial direction of the first output shaft and the second output shaft, and
the drag generation portion is configured to be displaced in the axial direction by action of the magnetic force from the output shaft switching device to come into contact with the one of the first output shaft and the second output shaft.

10. The power transmission device according to claim 8, wherein
the first output shaft and the second output shaft are provided inside the accommodation space and configured to be displaced in the axial direction of the first output shaft and the second output shaft, and
the drag generation portion is provided at a position to be in contact with one of the first output shaft and the second output shaft when displaced in the axial direction by action of the magnetic force from the output shaft switching device.

11. The power transmission device according to claim 8, wherein
among surfaces of the first output shaft and the second output shaft, a facing face faces the drag generation portion in the axial direction of the first output shaft and the second output shaft,
one of the drag generation portion and the facing face has a protrusion protruding in the axial direction of the first output shaft and the second output shaft, and
an other of the drag generation portion and the facing face has a recess recessed in the axial direction of the first output shaft and the second output shaft and configured to be fitted with the protrusion.
